(19) United States
(12) Patent Application Publication
(10) Pub. No.: US 2011/0016643 A1
(43) Pub. Date: Jan. 27, 2011

(54) PROCESSES AND APPARATUSES FOR APPLYING A BENEFIT COMPOSITION TO ONE OR MORE FABRIC ARTICLES DURING A FABRIC ENHANCEMENT OPERATION

(76) Inventors: Dean Larry DuVal, Lebanon, OH (US); Michael Joseph Orr, West Chester, OH (US); Mary Jane Combs, Covington, KY (US); Eugene Joseph Panchieri, Cincinnati, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/891,220

(22) Filed: Sep. 27, 2010

Related U.S. Application Data
(63) Continuation of application No. 10/839,549, filed on May 5, 2004.
Application No. 10/839,549 is a continuation-in-part of application No. 10/762,152, filed on Jan. 21, 2004, now Pat. No. 7,503,127.
Application No. 10/762,152 is a continuation-in-part of application No. 10/697,736, filed on Oct. 29, 2003, now abandoned.
Application No. 10/697,736 is a continuation-in-part of application No. 10/697,734, filed on Oct. 29, 2003, now abandoned.
Application No. 10/697,734 is a continuation-in-part of application No. 10/697,685, filed on Oct. 29, 2003, now Pat. No. 7,043,855.
Application No. 10/697,685 is a continuation-in-part of application No. 10/697,735, filed on Oct. 29, 2003, now Pat. No. 7,146,749.
Application No. 10/697,735 is a continuation-in-part of application No. 10/418,595, filed on Apr. 17, 2003, now Pat. No. 7,059,065.
(60) Provisional application No. 60/374,601, filed on Apr. 22, 2002.

(51) Int. Cl. D06L 1/00; C11D 3/00; F26B 19/00

(52) U.S. Cl. 8/442; 8/147; 8/137; 34/60

(57) ABSTRACT

A process is provided for applying a benefit composition to a fabric article during a fabric enhancement operation. The process may comprise the steps of selecting a desired one of two or more levels of a benefit to be provided by the benefit composition to the fabric article, and selecting one dosage amount for the benefit composition based on the selected benefit level.

### CROSS-REFERENCE TO RELATED APPLICATIONS

This application is a continuation of U.S. Ser. No. 10/839,549 filed on May 5, 2004; which is a continuation-in-part of U.S. Ser. No. 10/762,152, filed on Jan. 21, 2004; which is a continuation-in-part of U.S. Ser. No. 10/697,736, filed on Oct. 29, 2003; U.S. Ser. No. 10/697,734 filed on Oct. 29, 2003; U.S. Ser. No. 10/697,685, filed on Oct. 29, 2003; and U.S. Ser. No. 10/697,735, filed Oct. 29, 2003; each of which is a continuation-in-part of U.S. Ser. No. 10/418,595, filed on Apr. 17, 2003, which claims the benefit of U.S. Provisional Application Ser. No. 60/374,601, filed Apr. 22, 2002 and U.S. Provisional Application Ser. No. 60/526,438, filed Nov. 14, 2002.

### FIELD OF THE INVENTION

This application relates to processes and apparatuses for applying a benefit composition to one or more fabric articles during a fabric enhancement operation.

### BACKGROUND OF THE INVENTION

U.S. Pat. No. 4,642,908 discloses a dispenser positioned within a dryer for metering and dispensing small amounts of a fluid additive to a dryer. The fluid additive may comprise anti-static and/or fabric softening agents. A switch is provided to allow a user to determine whether additive should be dispensed to a particular clothes load. The '908 patent also teaches that the metering of the additive should preferably occur at or near the beginning of a drying cycle. The '908 patent does not teach structure for allowing a user to customize or select a benefit level provided by an anti-static and/or fabric softening composition.

It would be advantageous to have a device, either as a stand-alone unit to be used in combination with a fabric enhancement apparatus, such as a dryer, or incorporated into a fabric enhancement apparatus, for allowing a user to select one or more desired benefits to be provided by a benefit composition to a fabric article during a fabric enhancement operation. It would also be advantageous to have a device, either as a stand-alone unit to be used in combination with a fabric enhancement apparatus or incorporated into a fabric enhancement apparatus, for allowing a user to select one of two or more levels of a benefit to be provided by a benefit composition to a fabric article during a fabric enhancement operation.

### BRIEF SUMMARY OF THE INVENTION

These needs are met by the present invention wherein a device is provided, either as a stand-alone unit to be used in combination with a fabric enhancement apparatus, such as a dryer, or incorporated into a fabric enhancement apparatus, for allowing a user to select one or more desired benefits to be provided by a benefit composition to a fabric article during a fabric enhancement operation. Based on the selected one or more benefits, a controller forming part of the device selects an optimum time for applying the benefit composition to the fabric article during the fabric enhancement operation. Further provided is a device, either as a stand-alone unit to be used in combination with a fabric enhancement apparatus or incorporated into a fabric enhancement apparatus, for allowing a user to select one of two or more levels of a benefit to be provided by a benefit composition to a fabric article during a fabric enhancement operation. Based on the selected benefit level, a controller forming part of the device selects at least one of a dosage amount for the benefit composition and/or optimum time for applying the benefit composition. Additional embodiments of the present invention are discussed below.

### BRIEF DESCRIPTION OF THE SEVERAL VIEWS OF THE DRAWINGS

FIG. 1 is a perspective view of an embodiment of a stand-alone unit for dispensing a benefit composition constructed according to the principles of the present invention;

FIG. 2 is a perspective view from an opposite angle of the unit of FIG. 1;

FIG. 3 is a side view, part in cross-section, of the device of FIG. 1;

FIG. 4 is a front view, part in cross-section, of the device of FIG. 1;

FIG. 5 is a block diagram of at least a portion of the electrical and mechanical components utilized in the unit of FIG. 1;

FIG. 6 is a side view of the unit of FIG. 1 fitted over a dryer door, shown in cross section;

FIG. 7 is a perspective view of a fabric enhancement apparatus having a benefit composition dispensing apparatus constructed in accordance with an alternative embodiment of the present invention;

FIG. 8 illustrates a flow chart of a process in accordance with a first embodiment of the present invention for determining an amount of benefit composition to be dispensed during a fabric enhancement operation;

FIG. 8A illustrates an input device corresponding to the FIG. 8 process;

FIG. 8B illustrates an alternative input device corresponding to the FIG. 8 process;

FIG. 9 illustrates a flow chart of a process in accordance with a second embodiment of the present invention for selecting an optimum time for applying a benefit composition during a fabric enhancement operation;

FIG. 9A illustrates a flow chart of a process for initiating the step of dispensing the benefit composition in accordance with the optimum time selected via the process of FIG. 9;

FIG. 10 illustrates a flow chart of a process in accordance with a third embodiment of the present invention for selecting at least one dosage amount for applying a benefit composition;

FIG. 10A illustrates an input device corresponding to the FIG. 10 process;

FIG. 11 illustrates a flow chart of a process in accordance with a fourth embodiment of the present invention for selecting at least one dosage amount for applying a benefit composition;

FIG. 11A illustrates an input device corresponding to the FIG. 11 process;

FIG. 12 illustrates a flow chart of a process in accordance with a fifth embodiment of the present invention for selecting at least one dosage amount for applying a benefit composition;

FIG. 12A illustrates an input device corresponding to the FIG. 12 process;

FIG. 13 illustrates a flow chart of a process in accordance with a sixth embodiment of the present invention for selecting at least one dosage amount for applying first and second benefit compositions;

FIG. 13A illustrates an input device corresponding to the FIG. 13 process;

FIG. 14 illustrates a flow chart of a process in accordance with a seventh embodiment of the present invention for applying a benefit composition;

FIG. 14A illustrates an input device corresponding to the FIG. 14 process;

FIG. 15 is a perspective view of another embodiment of a stand-alone unit for dispensing a benefit composition constructed according to the principles of the present invention;

FIG. 16 is a perspective view from an opposite angle of the unit of FIG. 15;

FIG. 17 is an exploded view of the unit illustrated in FIGS. 15 and 16;

FIG. 17A is an exploded view of the fluid container, the first and second fitments and the first and second mounting shelves; and

FIG. 18 is a block diagram of at least a portion of the electrical and mechanical components utilized in the unit of FIGS. 15-17.

### DETAILED DESCRIPTION OF THE INVENTION

“Fabric article” (or “fabric”) as used herein means any article that is customarily cleaned in a conventional laundry process or in a dry cleaning process. The term encompasses articles of fabric including but not limited to: clothing, linen, draperies, clothing accessories, leather, floor coverings, sheets, towels, rags, canvas, polymer structures, and the like. The term also encompasses other items made in whole or in part of fabric material, such as tote bags, furniture covers, tarpaulins, shoes, and the like.

As used herein, the term “benefit composition” refers to a composition used to deliver a benefit to a fabric article. Non-limiting examples of materials and mixtures thereof which can comprise the benefit composition include: water, softening or softness enhancement agents, crispening agents, perfume or scent enhancement agents, water/stain repellents, refreshing agents, antistatic agents, antimicrobial or bacterial reducing agents, durable press agents, wrinkle resistant or reduction agents, odor resistance agents, abrasion resistance agents, color protection agents, whiteness protection agents, solvents, and combinations thereof.

As used herein, the articles “a” and “an,” when used in a claim, are understood to mean one or more of the material, element, or step that is claimed or described.

As used herein, “a fabric enhancement operation” means a drying, tumbling or washing operation.

As used herein, “an apparatus for effecting a fabric enhancement operation” or “a fabric enhancement apparatus” means a drying, tumbling or washing appliance, such as a clothes dryer or a laundry machine.

As used herein, “a benefit composition dispensing apparatus” or “an apparatus for dispensing a benefit composition” means a stand-alone controller and dispenser unit for dispensing a benefit composition during a fabric enhancement operation, an apparatus integrated into a fabric enhancement apparatus for dispensing a benefit composition during a fabric enhancement operation, or a similar device. “A benefit composition dispensing apparatus” is equivalent to a “fabric article treating apparatus.”

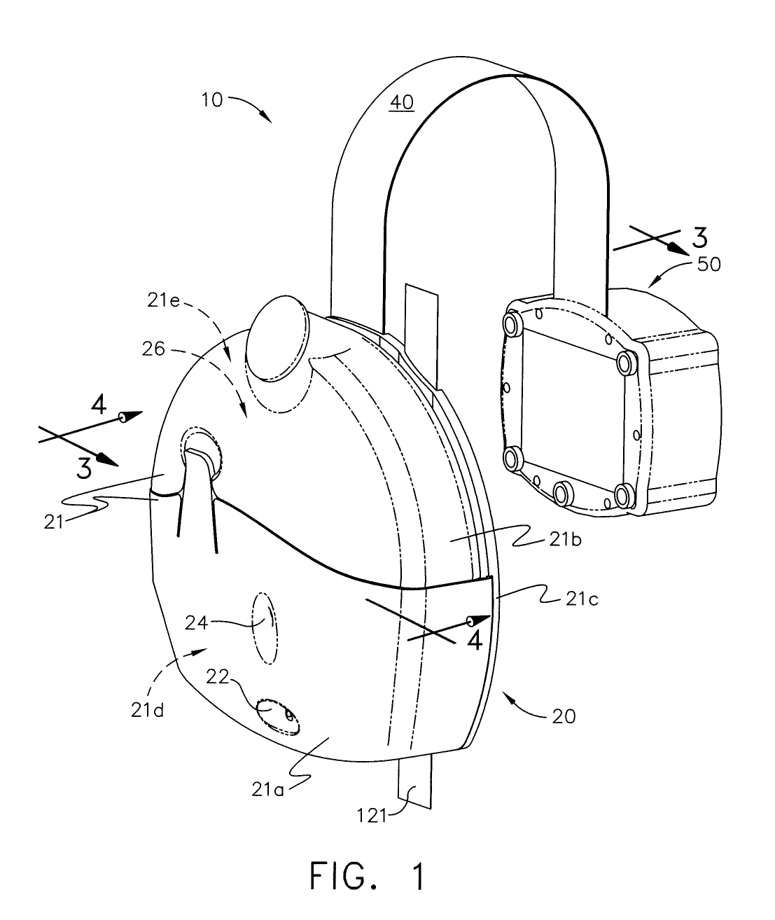

A “stand-alone” controller and dispenser unit 10 (also referred to herein as an apparatus for dispensing a benefit composition) comprising a self-contained device and which functions in accordance with the present invention is illustrated in FIGS. 1-6. The device 10 is constructed in a similar manner to device 10 described in commonly assigned, copending application U.S. Ser. No. 10/762,152, entitled “Volatile Material Delivery Method.”

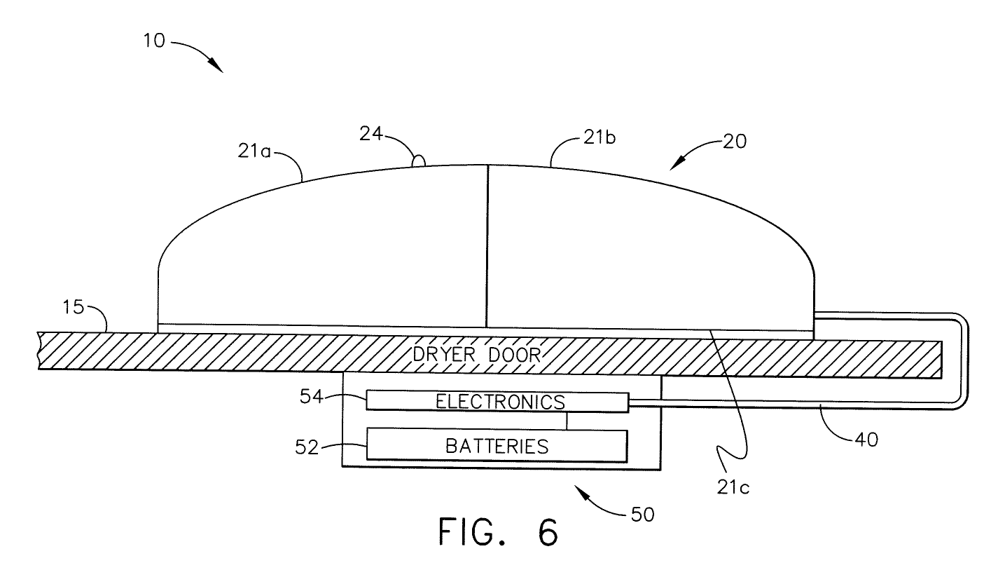

As illustrated in FIGS. 1-6, the unit 10 comprises two major enclosures or housings 20 and 50. Enclosure 20 defines an “inner housing” located in an interior of a fabric enhancement apparatus such as fabric article drying appliance, e.g., a clothes dryer (not shown in FIGS. 1-4; a dryer door 15 is illustrated in FIG. 6), while the enclosure 50 defines an “outer housing” located outside of the fabric article drying appliance. The enclosure 50 may be mounted on the exterior surface of the fabric article drying appliance door 15, see FIG. 6. Alternatively, the enclosure 50 may be mounted on any other exterior surface of the drying appliance, non-limiting examples of which include: side walls, top walls, an outer surface of a top-opening lid, and the like. The enclosure 50 may also be mounted on a wall or other household structure that is separate from the fabric article-drying appliance. Furthermore, the enclosure 20 may be mounted on any interior surface of the fabric article drying appliance, examples of which include, but are not limited to: the interior surface of the door, the drum of the fabric article drying appliance, the back wall, the inner surface of a top-opening lid, and the like.

Enclosure 50 may be permanently mounted to the exterior surface of the door 15, or preferably releasably attached to the exterior surface of the door 15. Likewise, enclosure 20 may be permanently mounted to the interior surface of the door 15, or releasably attached to the interior surface of the door 15.

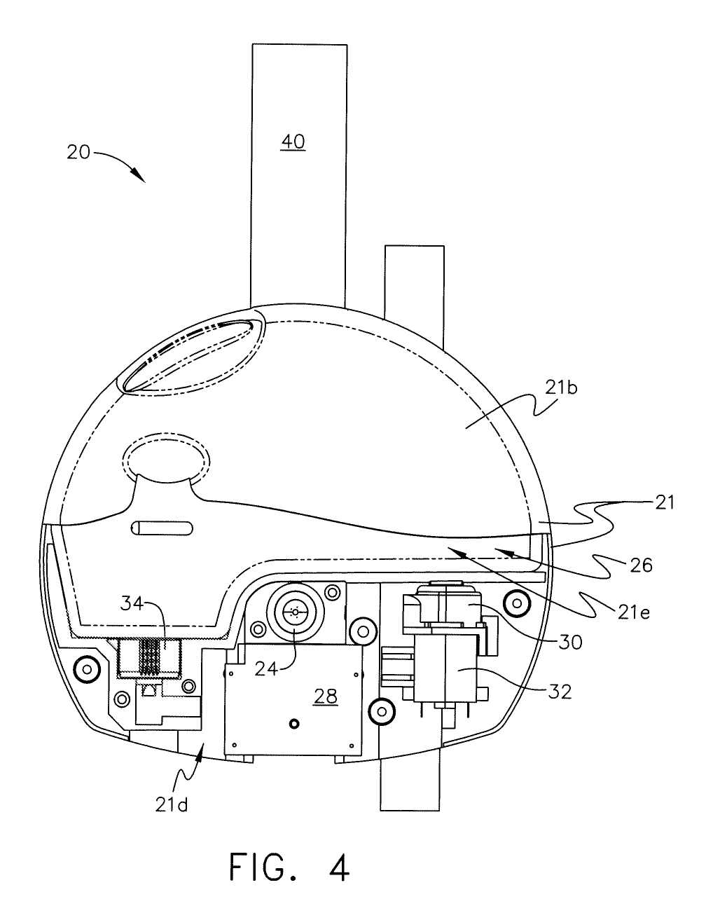

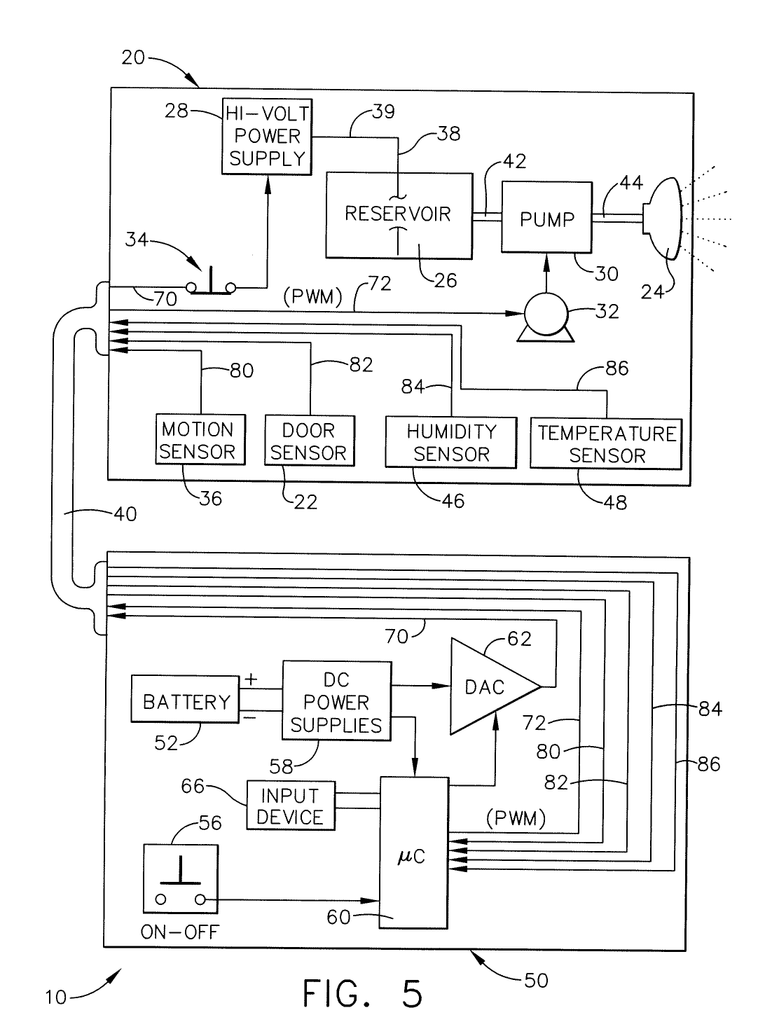

As illustrated in FIGS. 1 and 4, the inner housing enclosure 20 comprises a main body 21 comprising removable first and second front sections 21a and 21b (the first front section 21a is removed in FIGS. 3 and 4) and base portion 21c. The main body 21 includes a first compartment 21d containing a discharge nozzle 24, a pump 30, a motor 32 for driving the pump 30, a door sensor 22 (not shown), which senses ambient light when the door 15 is open, and a second compartment 21e defining a benefit composition-holding reservoir 26. In the illustrated embodiment, the nozzle 24 is combined with an optional high voltage power supply 28, see FIGS. 4 and 5, such that the nozzle 24 functions as an electrostatic nozzle. The high voltage power supply 28 functions to electrically charge the fluid, i.e., the benefit composition, prior to being dispensed through the discharge nozzle 24. A quick disconnect switch 34 is included for safety purposes, so that the high voltage power supply 28 can be quickly shut down if necessary. Alternatively, a high voltage power supply 28 need not be provided. In such a case, the discharge nozzle 24 may function as a fluid atomizing nozzle so as to generate a pressurized spray. A non-limiting example of a nozzle suitable for this purpose is a pressure swirl atomizing nozzle. Non-limiting examples of suitable nozzles include the Cosmos 13 NBU nozzle manufactured by Precision Valve Corporation of Marietta, Ga., the WX12 and WD32 nozzles manufactured by Saint-Gobain-Calmar USA, Inc. of City of Industry, Calif., and Seaquist Model No. DU-3813 manufactured by Seaquist Dispensing of Cary, Ill. The nozzle may be in association with a spraying device. The nozzle may be permanently attached or releasably attached to a spraying device. One non-limiting example is a nozzle which is threaded such that it can easily be removed from or placed in a spraying device. The nozzle may be disposable.

The benefit composition can comprise a liquid or a gaseous compound, or it can comprise a solid compound in the form of particles, such as a powder, or solid particles in solution with a liquid. Reservoir 26 can be of essentially any size and shape, and can be sealed so as to hold a fluid in a sealed manner. Alternatively, the reservoir 26 may be adapted to receive a container filled with the benefit composition, such as a polymeric bag filled with the benefit composition, which container is replaced when empty. Still further, the reservoir 26 may be coupled to a continuous fluid source, such as a household water line.

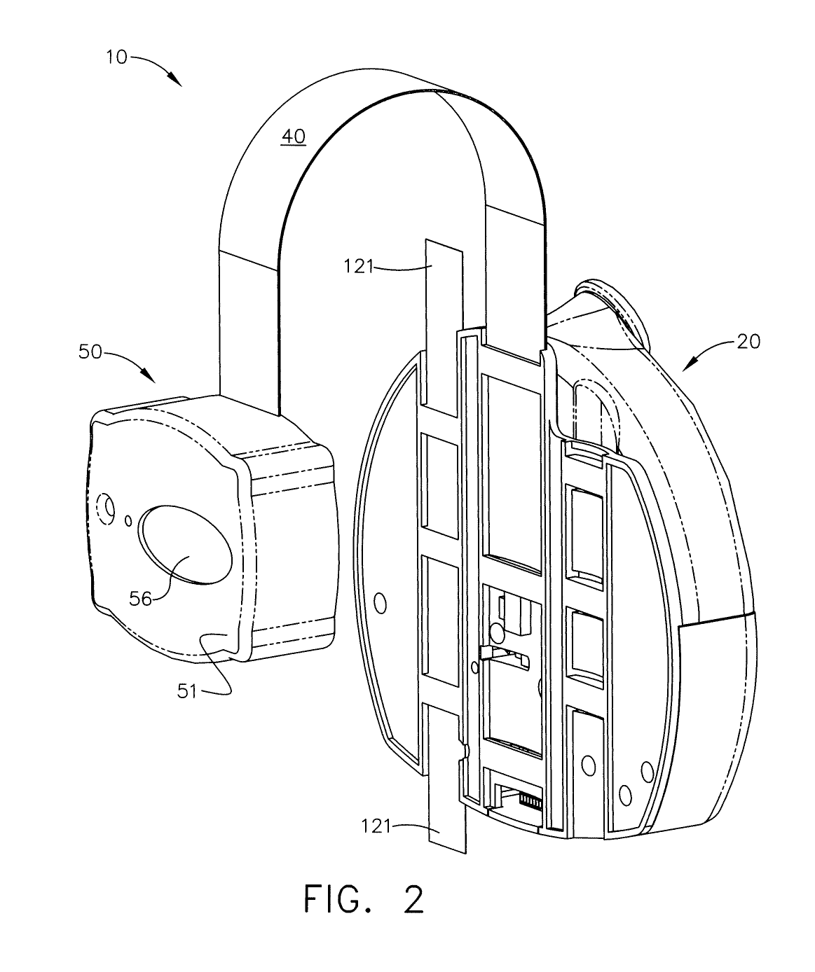

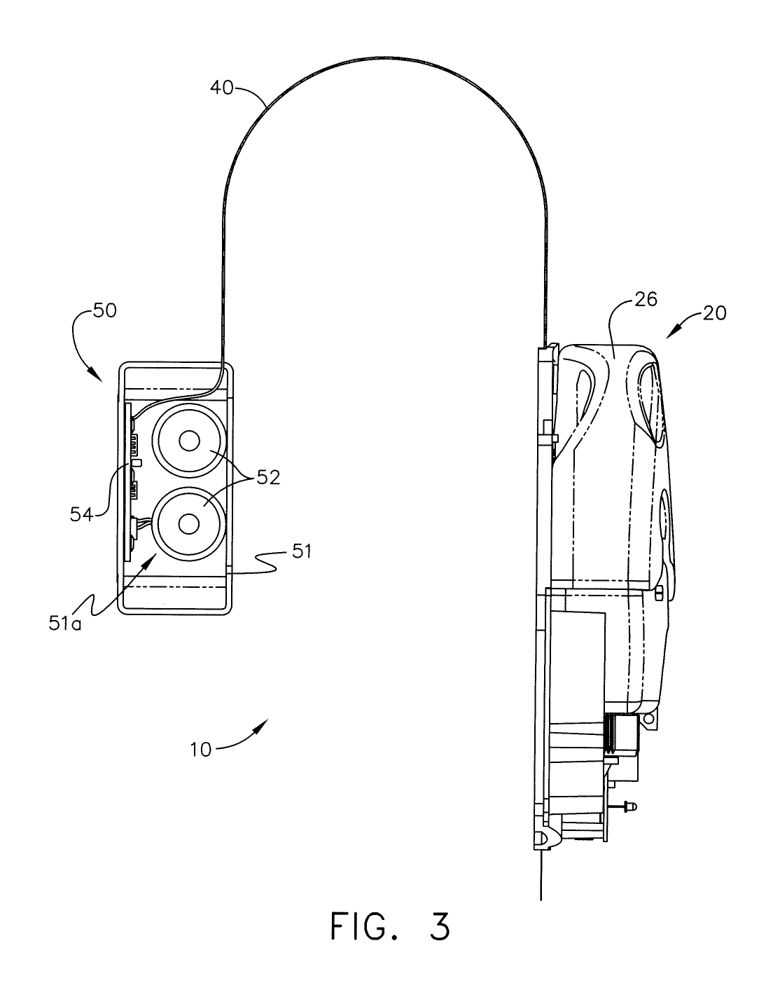

As best illustrated in FIGS. 2 and 3, the enclosure 50 comprises a main body 51 having an inner compartment 51a, an ON-OFF switch 56 (not shown in FIG. 3) extending through the main body 51, batteries 52 housed within the main body inner compartment 51a, and a printed circuit board with electronic components 54. Any type of electrical power source may be used in the present invention, including standard household line voltage, or even solar power.

An adhesive strip 121, illustrated in FIG. 2, is provided for mounting the enclosure 20 to the door 15.

In the embodiment of FIGS. 1-6, a flat cable 40 (also referred to as a “ribbon cable”) is coupled to and extends between the enclosures 20 and 50. The cable 40 may run along the inner surface of the fabric article drying appliance door 15, over the top of the door 15, and down the exterior surface of the door 15, see FIG. 6. The cable 40 carries command or control signals and electrical power from the outer housing 50 to the inner housing 20, and carries electrical signals from sensors mounted in the inner housing 20 to the outer housing 50.

With reference to FIG. 5, a microcontroller 60 generates a digital power supply signal which is converted to an analog signal via a digital-to-analog converter (DAC) 62. An example of such a converter 62 is commercially available from Analog Devices of Norwood, Mass. (Part No. AD 5301). The analog control signal is carried over a conductor 70, which is schematically illustrated in FIG. 5 as passing through the cable 40, through the quick disconnect switch 34 and to the high voltage power supply 28. This signal can comprise a constant DC voltage, a constant AC voltage, a variable DC voltage, a variable AC voltage, or a pulsed voltage. In one embodiment, the signal at 70 comprises a variable DC voltage signal. As this voltage signal increases, the magnitude of the voltage output of the high voltage power supply 28 correspondingly increases. The output of the high voltage power supply 28 is carried by conductor 39 to an electrode 38, which, in turn, carries the high voltage to the benefit composition in the reservoir 26. A constant output DC high voltage power supply could optionally be used instead of the variable output high voltage power supply 28 of the exemplary embodiment. The high voltage power supply 28 is grounded to the drying appliance via a grounding wire or pin (not shown).

The charged benefit composition travels from the reservoir 26 via a tube or channel 42 to the inlet of the pump 30, after which the composition is pressurized and carried via another tube or channel 44 to the discharge nozzle 24 where the benefit composition is discharged.

It should be noted that some types of pumps do not require separate input and output lines, such as peristaltic pumps, in which the pump acts upon a continuous tube that extends through an inlet opening and continues through a discharge opening of the pump. This arrangement is particularly beneficial for use with electrostatically charged fluids or particles that are being pumped to the discharge nozzle 24, because the tubing can electrically insulate the pump from the charged benefit composition. A non-limiting example of a suitable peristaltic pump is the Model 10/30 peristaltic pump, which may be obtained from Thomas Industries of Louisville, Ky. It should also be noted that an alternative pumping device could be used, if desired, such as a spring-actuated pumping mechanism.

The types of control signals used to control the electric motor 32 can vary according to the design requirements of the apparatus 10, and such signals will travel to the motor 32 via an electrical conductor 72, which conductor is schematically illustrated in FIG. 5 as passing through the cable 40. If the motor 32 is a DC variable-speed motor, then a variable “steady” DC voltage can be applied, in which the greater the voltage magnitude, the greater the rotational speed of the motor. In one embodiment, the electrical signal traveling along conductor 72 comprises a pulse-width modulated (PWM) signal controlled by the microcontroller 60. Of course, such a pulse-width modulated signal can also be generated by any appropriate controller or processor, or appropriate discrete logic.

The unit 10 can be enhanced by use of certain sensors, examples of which include but are not limited to a door (or lid) sensor 22, a motion sensor 36, a humidity sensor 46, and/or a temperature sensor 48. An analog output temperature sensor can be used to provide an analog signal along the electrical conductor 86 that leads back to the microcontroller 60 in the outer housing 50. (It should be noted that some temperature sensors have a serial bus to carry a digital output signal, rather than outputting an analog voltage.) The interior temperature of the drying appliance could be used to determine the proper environmental conditions for certain spraying events to occur, particularly if a spraying event of the benefit composition in reservoir 26 is to take place during a “cool down” cycle of the drying appliance. In addition, the temperature sensor 48 can also be used as an indicator that the drying appliance is not operating properly, for example, if the drying appliance has not warmed up to a predetermined minimum temperature.

As noted above, the enclosure 50 comprises batteries 52 housed within the main body inner compartment 51a, and a printed circuit board with electronic components 54. In the illustrated embodiment, the batteries 52 define a power source. For example, if four D-cell batteries are connected in series, a +6 volt DC voltage will be provided to a set of DC power supplies generally designated by the reference numeral 58. Example DC power supplies are set out in commonly assigned, copending U.S. application Ser. No. 10/762,152, entitled “Volatile Material Delivery Method.” One of the DC power supplies provides a voltage to the microcontroller 60. A further output voltage is provided to the digital-to-analog converter (DAC) 62, which may requires a +5 volt DC power supply. All of these power supplies are designated by the “set” of DC power supplies 58.

An input device 66 is coupled to the microcontroller 60 so as to allow a user to interface with the microcontroller 60. The device 66 may include a keypad (not shown) for allowing a user to input into the device 66 the total time of a drying, tumbling or other fabric enhancement operation cycle. A start key (not shown) may be provided such that when it is activated by a user, it generates a signal to the microcontroller 60 indicating that the drying, tumbling or other fabric enhancement operation cycle has started.

A suitable microcontroller 60 is one manufactured by Microchip of Chandler, Ariz., under the Part No. PIC 16LF876-04/P. Of course, other microcontrollers, microprocessors, controllers, or processors made by different manufacturers, or discrete digital logic could alternatively be used.

The microcontroller 60 includes on-board memory and input and output lines for analog and digital signals. The microcontroller 60 also has a serial port that can be interfaced to an optional programmer interface using an RS-232 communications link. An ON-OFF switch 56 is coupled to the microcontroller 60, see FIG. 5. The ON-OFF switch 56 may be coupled with a corresponding key (not shown) on the input device 66. As noted above, the motion sensor 36, door sensor 22, humidity sensor 46 and temperature sensor 48 generate signals to the microcontroller 60. As also noted above, the microcontroller 60 generates a pulse-width modulated (PWM) signal to the pump motor 32 via the conductor 72. That signal drives a transistor (not shown but illustrated in application U.S. Ser. No. 10/762,152), which functions to convert the signal to a higher voltage for driving the motor 32. A voltage shifting circuit of first and second transistors (not shown but illustrated in application U.S. Ser. No. 10/762,152), receives DAC control outputs from the microcontroller 60, and function to shifts the signals from 3.3 volt logic levels to +5 volt logic levels to control the DAC 62.

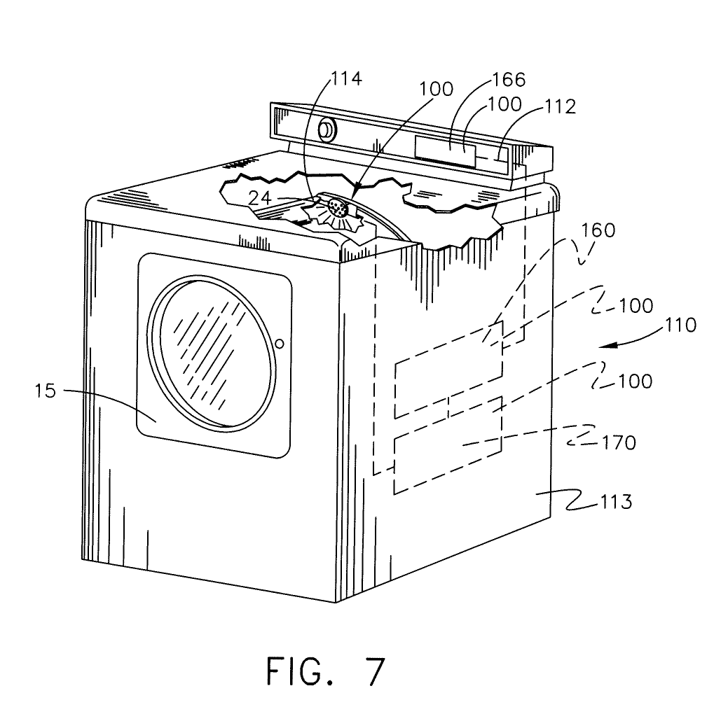

In FIG. 7, where like reference numerals indicate like elements, a benefit composition dispensing apparatus 100 constructed in accordance with a second alternative embodiment of the present invention is illustrated. In this embodiment, the dispensing apparatus 100 is integrated into an apparatus 110 for effecting a fabric enhancement operation. The apparatus 110 comprises a drying appliance for effecting a drying operation. However, it is contemplated that the apparatus 110 may alternatively comprise a washing appliance for effecting a conventional laundry process or an apparatus capable of effecting both laundry and drying processes. An input device 166, forming part of the dispensing apparatus 100, is integrated into the control panel 112 of the fabric enhancement apparatus 110. Input device 166 may include the same keys provided on input device 66 described above. A control module 160, also forming part of the dispensing apparatus 100, is housed within a main cabinet 113 of the apparatus 110 and may contain many of the elements provided in enclosure 50 described above; namely, batteries 52, DC power supplies 58, ON/OFF switch 56, microcontroller 60 and DAC 62. A fluid supply module 170, additionally forming part of the dispensing apparatus 100, is housed within the main cabinet 113 of the apparatus 110 and contains each of the elements contained in enclosure 20 described above, save for the nozzle 24; namely, sensors 22, 36, 46 and 48, high voltage power supply 28, reservoir 26, pump 30 and motor 32. Doors (not shown) may be provided in the cabinet 113 to allow a user to gain access to the control and fluid supply modules 160 and 170.

It is contemplated that the functions performed by the microcontroller 60 may alternatively be performed by a controller provided in the apparatus 110 which also functions to control the operation of the structure within the apparatus 110 for effecting the drying process, the laundry process or both drying and laundry processes. It is further contemplated that, instead of using batteries 52, a power supply receiving AC line voltage may provide power to the control module 160.

As is apparent from FIG. 7, a nozzle 24, which forms part of the dispensing apparatus 100, directs a spray of the benefit composition into a rotating drum 114 of the apparatus 110 in which clothes are tumbled. A heat source is provided so as to effect drying of the clothes as they are tumbled within the drum 114. It is also contemplated that the heat source may be turned off such that clothes in the drum 114 are subjected to a tumbling operation in the absence of heat. Such an operation may be beneficial, when combined with the dispensing of an appropriate benefit composition, to remove wrinkles from clothes that have remained in the drum 114 for an extended period of time. This wrinkle removing operation is referred to herein as a “refluff” operation. It is also contemplated that a “refluff” operation may occur with heat provided to the interior of the drum. A door 115 is provided for allowing a user to input and remove clothes from the drum 114.

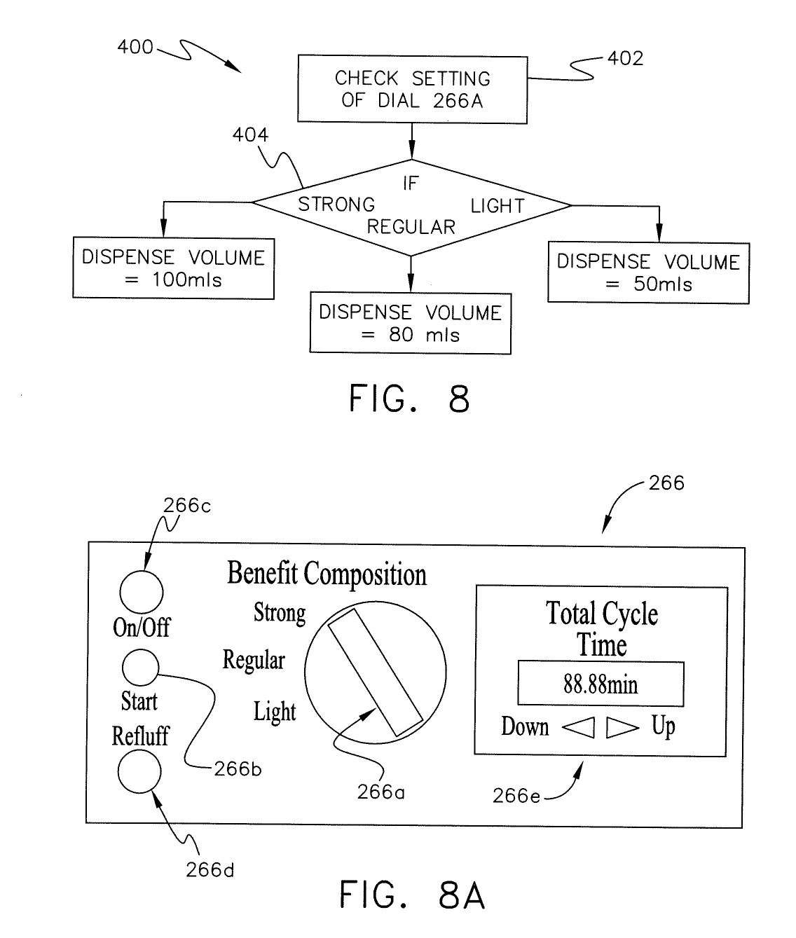

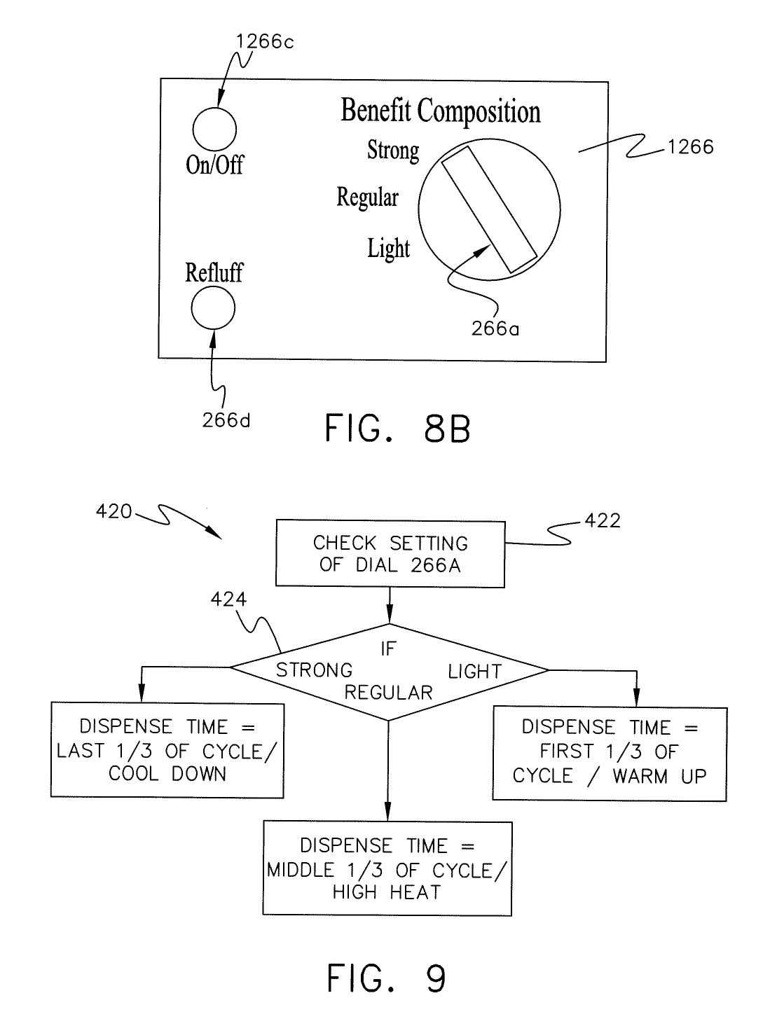

Referring to FIG. 8, a flow chart illustrates a process 400 in accordance with a first embodiment of the present invention for determining an amount of benefit composition to be dispensed during a fabric enhancement operation, i.e., a drying, tumbling or washing operation. The benefit composition may be dispensed via the nozzle 24 provided, for example, in unit 10 illustrated in FIGS. 1-6, or nozzle 24 provided in dispensing apparatus 100 illustrated in FIG. 7. The microcontroller 60 causes the benefit composition to be dispensed at desired times during a fabric enhancement operation by generating appropriate pulse-width modulated (PWM) signals to the pump motor 32 via the conductor 72. The process 400 may be implemented by software instructions executed on the microcontroller 60. The software instructions are stored in memory within the microcontroller 60 and may be downloaded to the controller 60 via its serial port.

Prior to the fabric enhancement operation, a user dials in a desired benefit level via a dial 266a on an input device 266, see FIG. 8A. The input device 266 may be incorporated into the enclosure 50 of the unit 10 of FIGS. 1-6 as a substitute for device 66, or into the control panel 112 of the apparatus 110 of FIG. 7 as a substitute for device 166. In the illustrated embodiment, a user rotates the dial to a desired one of a strong, regular or light setting corresponding to a strong, regular or light benefit level to be provided by a benefit composition to at least one fabric article during the fabric enhancement operation. The dial 266a generates an appropriate analog or digital signal to the microcontroller 60 corresponding to the selected benefit level. The benefit composition to be dispensed during the fabric enhancement operation may provide one or more benefits such as softness enhancement, color protection, whiteness protection, stain repellency, scent enhancement, static reduction, bacterial reduction and wrinkle reduction. For example, if the benefit composition provides softness enhancement, a strong benefit level would correspond to a high amount of softness enhancement, a regular benefit level would corresponding to an intermediate amount of softness enhancement and a light benefit level would correspond to a low amount of softness enhancement. Alternatively, if the benefit composition provides a scent enhancement, a strong benefit level would correspond to a high amount of scent enhancement, a regular benefit level would corresponding to an intermediate amount of scent enhancement and a light benefit level would correspond to a low amount of scent enhancement.

At step 402, the microcontroller 60 checks the setting of dial 266a to determine which one of the strong, regular and light benefit levels was selected. At decision step 404, the microcontroller 60 determines an amount of benefit composition to be dispensed via the nozzle 24 during the fabric enhancement operation. If the strong benefit level is selected, then the microcontroller 60 determines that 100 milliliters of benefit composition will be dispensed during the fabric enhancement operation. If the regular benefit level is selected, the microcontroller 60 determines that 80 milliliters of benefit composition will be dispensed, and if the light benefit level is selected, the microcontroller 60 determines that 50 milliliters of benefit composition will be dispensed. Of course, the amounts corresponding to the strong, regular and light benefit levels may vary.

The microcontroller 60 may dispense the determined amount of benefit composition as a function of time. That is, presuming the flow rate through the nozzle 24 is generally constant, the dispensing of the benefit composition for a predefined time period results in a corresponding, predictable amount of benefit composition being dispensed. Hence, the software instructions may be written so as to cause the controller 60 to activate the pump 30 for a first predefined time period corresponding to 100 milliliters of benefit composition being dispensed; a second predefined time period corresponding to 80 milliliters of benefit composition being dispensed; or a third predefined time period corresponding to 50 milliliters of benefit composition being dispensed.

The microcontroller 60 may initiate the dispensing operation as a function of time, temperature or motion. For example, the microcontroller 60 may start the dispensing operation at a predefined time after rotation of a portion of the fabric enhancement apparatus, such as drum 114 of the apparatus 110 illustrated in FIG. 7, has begun. The rotation of the drum 114 may be sensed by motion sensor 36. Alternatively, the microcontroller 60 may initiate the dispensing of the benefit composition after the interior of the drum 114 has reached a predefined temperature. It is also contemplated that the microcontroller 60 may initiate the dispensing of the benefit composition after both of the following events have occurred: the temperature of the interior of the drum 114 has increased above a first predefined temperature, and, subsequently, the temperature of the interior of the drum 114 has dropped below a second predefined temperature, which is lower than the first predefined temperature. In this embodiment, the benefit composition is dispensed during the cool-down portion of a drying cycle, which typically occurs within the last ⅓ of the cycle. It is also contemplated that the microcontroller 60 may initiate the dispensing operation a predefined time period after the fabric enhancement operation has been initiated. A fabric enhancement operation total cycle time may be entered by the operator via a time entry module 266e forming part of the input device 266. Hence, the controller 60 may initiate the dispensing of the benefit composition at any point within the time period corresponding to the cycle, e.g., ⅓ of the way through the cycle. The start point of the fabric enhancement operation may be indicated to the microcontroller 60 by a user activating a “start” key 266b on the input device 266.

The input device 266 may also include an ON/OFF switch 266c for activating the unit 10 or dispensing apparatus 100. It may also include a “refluff” key 266d indicating to the controller 60 that a refluff operation has been started, i.e., a tumbling operation with or without heat for removing at least a portion of wrinkles from clothes which have remained in a dryer for an extended period of time.

An input device 1266 constructed in accordance with an alternative embodiment of the present invention is illustrated in FIG. 8B, where like elements are referenced by like reference numerals. In this embodiment, the ON/OFF switch 1266c performs two functions. It activates the unit 10 or dispensing apparatus 100 and also generates a start signal to the microcontroller 60 indicating that the fabric enhancement operation has begun. Also, a time entry module 266e is not provided. Hence, in this embodiment, the microcontroller 60 initiates the dispensing operation as a function of temperature or motion.

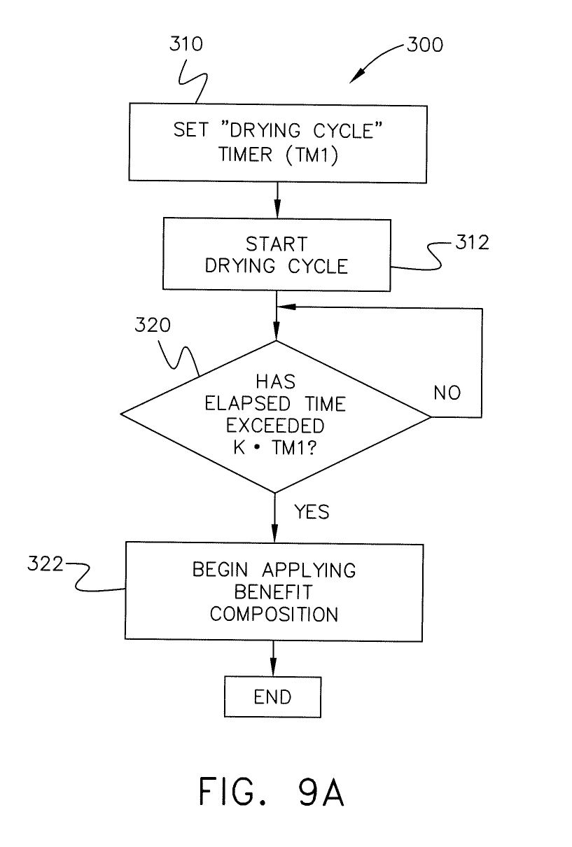

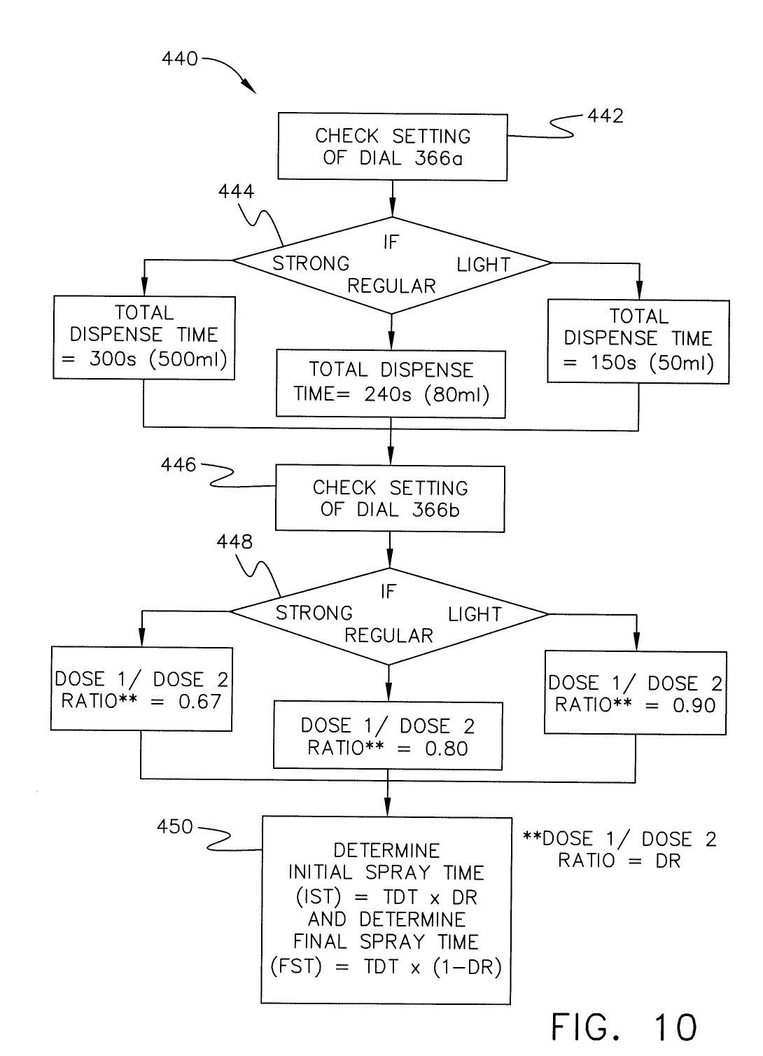

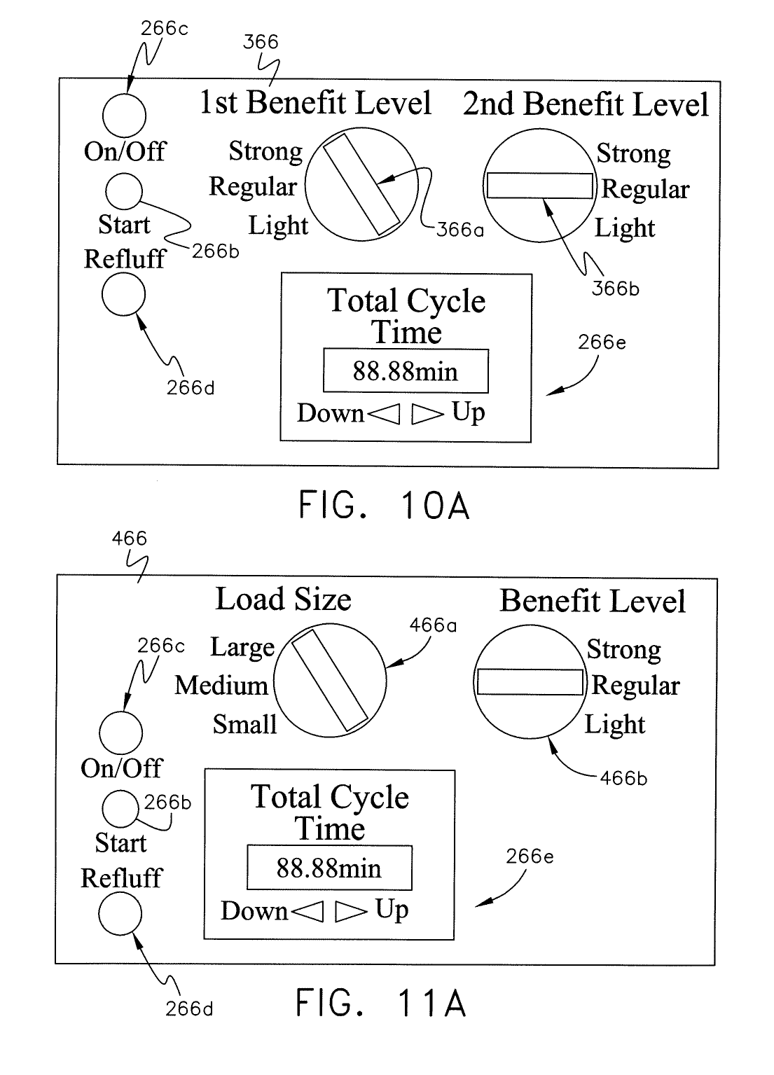

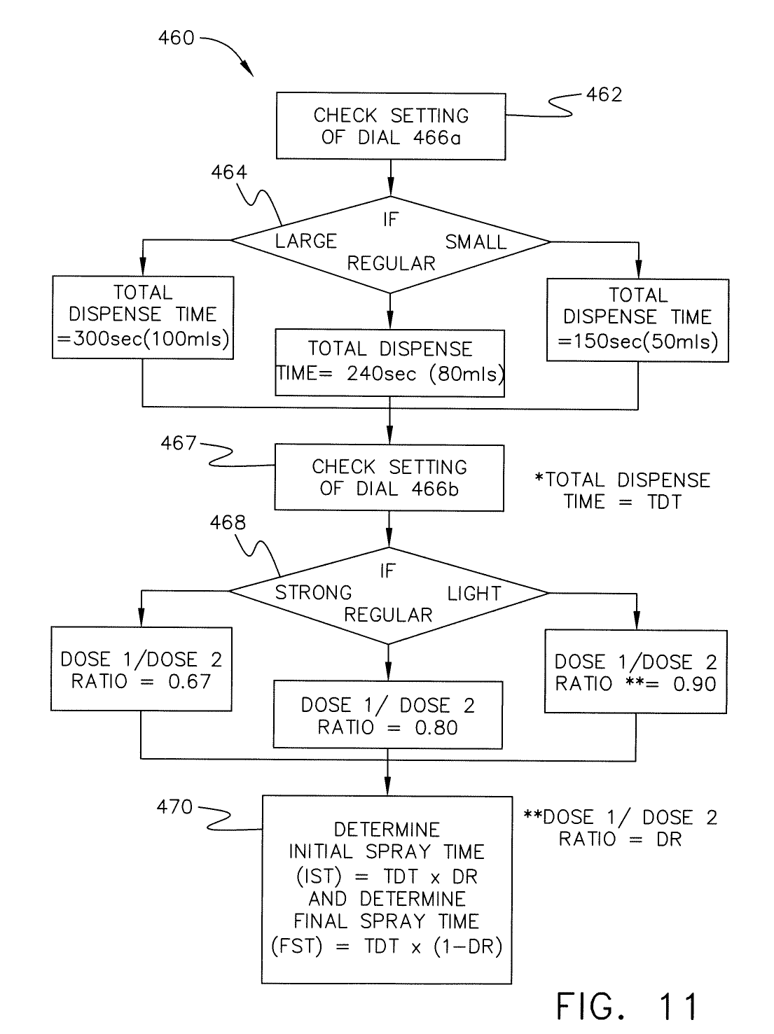

Referring to FIG. 9, a flow chart illustrates a process 420 in accordance with a second embodiment of the present invention for selecting an optimum time for applying a benefit composition to a fabric article during a fabric enhancement operation, i.e., a drying, tumbling or washing operation. The benefit composition may be dispensed via the nozzle 24 provided, for example, in unit 10 illustrated in FIGS. 1-6, or nozzle 24 provided in dispensing apparatus 100 illustrated in FIG. 7. The microcontroller 60 causes the benefit composition to be dispensed at desired times during a fabric enhancement operation by generating appropriate pulse-width modulated (PWM) signals to the pump motor 32 via the conductor 72. The process 420 may be implemented by software instructions executed on the microcontroller 60.

Prior to the fabric enhancement operation, a user dials in a desired benefit level via dial 266a on input device 266, see FIG. 8A.

At step 422, the microcontroller 60 checks the setting of dial 266a to determine if the strong, regular or light benefit level was selected. At decision step 424, the microcontroller 60 determines a time within the fabric enhancement operation cycle for initiating the dispensing of the benefit composition. If the strong benefit level is selected, then the controller determines that the benefit composition will be dispensed during the last ⅓ of the cycle, which may correspond to an optimum time value of 0.67. If the fabric enhancement operation is a drying cycle, the final ⅓ of that cycle may comprise a cool-down segment. It is believed that compositions which provide one or more of scent enhancement, static reduction, bacterial reduction and wrinkle reduction may perform best if applied during the last ⅓ of a drying cycle. If the regular benefit level is selected, the microcontroller 60 determines that the benefit composition will be dispensed during the middle portion of the fabric enhancement cycle, which may correspond to an optimum time value of 0.33. If the fabric enhancement operation comprises a drying cycle, the mid-portion of that cycle may comprise a high-heat segment. If the light benefit level is selected, the microcontroller 60 determines that the benefit composition will be dispensed during the first ⅓ of the cycle, which may correspond to an optimum time value of 0. If the fabric enhancement operation comprises a drying cycle, the first ⅓ of that cycle may comprise a warm-up segment.

Alternatively, it is contemplated that the strong benefit level may correspond to dispensing the benefit composition during the initial ⅓ of the cycle and the light benefit level may correspond to dispensing the benefit composition during the final ⅓ of the cycle. It is believed that compositions which provide one or more of softness enhancement, color protection, whiteness protection, and stain repellency may perform best if applied during the initial ⅓ of a drying cycle.

Referring to FIG. 9A, a flow chart illustrates a process 300 implemented by software instructions executed on the microcontroller 60 for initiating the step of dispersing the benefit composition in accordance with the optimum time selected via the steps of FIG. 9. Initially, the user inputs via the module 266e on the input device 266 a total fabric enhancement time period, e.g., a total drying cycle time. The microcontroller 60 stores that time period in memory as value TM1. A user may activate a start key 266b on the input device 266 to indicate to the microcontroller 60 that the fabric enhancement operation has begun. In step 320, the microcontroller 60 determines if the elapsed time has exceeded a time threshold, which is determined by multiplying the value TM1 by the optimum time value determined during process 400, discussed above. The optimum time value is designed by “K” in FIG. 9A. As noted above, if the benefit composition is to be dispensed during the initial ⅓ of the cycle, then the optimum time value is 0; if the benefit composition is to be dispensed during the middle portion of the cycle, then the optimum time value is 0.33; and if the benefit composition is to be dispensed during the final ⅓ of the cycle, then the optimum time value is 0.67. If the elapsed time has not exceeded the time threshold, then the microprocessor 60 returns to step 320. If the elapsed time has exceeded the time threshold, then the microprocessor proceeds to step 322, resulting in the microcontroller 66 initiating the dispensing of the benefit composition. The composition may be dispensed for a predefined period of time, e.g., 80 seconds.

Referring to FIG. 10, a flow chart illustrates a process 440 in accordance with a third embodiment of the present invention for selecting at least one dosage amount for applying a benefit composition during a fabric enhancement operation, i.e., a drying, tumbling or washing operation. The at least one dosage amount is selected based upon a user selecting a desired one of two or more levels of a first benefit to be provided by the benefit composition and a desired one of two or more levels of a second benefit to be provided by the benefit composition. The first benefit may comprise one or more of softness enhancement, color protection, whiteness protection and stain repellency. Typically, these benefits are accentuated if the benefit composition is dispensed during an initial segment of a fabric enhancement operation. The second benefit may comprise one or more of scent enhancement, static enhancement, bacterial reduction and wrinkle reduction. Typically, these benefits are accentuated if the benefit composition is dispensed during a final segment of the fabric enhancement operation. Hence, in this embodiment, it is presumed that the benefit composition is capable of providing at least one first benefit and at least one second benefit. The benefit composition may be dispensed via the nozzle 24 provided, for example, in unit 10 illustrated in FIGS. 1-6, or nozzle 24 provided in dispensing apparatus 100 illustrated in FIG. 7. The microcontroller 60 causes the benefit composition to be dispensed at desired times during a fabric enhancement operation by generating appropriate pulse-width modulated (PWM) signals to the pump motor 32 via the conductor 72. The process 440 may be implemented by software instructions executed on the microcontroller 60.

Prior to the fabric enhancement operation, a user dials in a desired first benefit level via dial 366a on an input device 366 and a desired second benefit level via dial 366b on input device 366, see FIG. 10A, where like reference numerals indicate like elements. The input device 366 may be incorporated into the enclosure 50 of the unit 10 of FIGS. 1-6 as a substitute for device 66, or into the control panel 112 of the apparatus 110 of FIG. 7 as a substitute for device 166. In the illustrated embodiment, a user rotates dial 366a to a desired one of a strong, regular or light setting corresponding to a strong, regular or light first benefit level to be provided by the benefit composition to be dispensed onto at least one fabric article during the fabric enhancement operation. The dial 366a generates an appropriate analog or digital signal to the microcontroller 60 corresponding to the selected benefit level. The user also rotates dial 366b to a desired one of a strong, regular or light setting corresponding to a strong, regular or light second benefit level to be provided by the benefit composition to be dispensed onto at least one fabric article during the fabric enhancement operation. The dial 366b generates an appropriate analog or digital signal to the microcontroller 60 corresponding to the selected benefit level.

At step 442, the microcontroller 60 checks the setting of dial 366a to determine which one of strong, regular and light benefit levels corresponding to the first benefit of the benefit composition was selected. At decision step 444, the microcontroller 60 determines an amount of benefit composition to be dispensed via the nozzle 24 during the fabric enhancement operation based on the selected level of the first benefit to be provided by the benefit composition. If the strong benefit level is selected, then the controller determines that 100 milliliters of benefit composition will be dispensed during the fabric enhancement operation. If the regular benefit level is selected, the microcontroller 60 determines that 80 milliliters of benefit composition will be dispensed, and if the light benefit level is selected, the microcontroller 60 determines that 50 milliliters of benefit composition will be dispensed. It may be presumed that the flow rate through the nozzle 24 is constant. Based on this presumption, the software instructions may be written such that the microcontroller 60 determines each benefit composition amount to be dispensed in terms of a total time period for dispensing the benefit composition. For example, a total dispense time of 300 seconds may correspond to 100 milliliters of the benefit composition being dispensed; 240 seconds may correspond to 80 milliliters of the benefit composition being dispensed; and 150 seconds may correspond to 50 milliliters of the benefit composition being dispensed.

At step 446, the microcontroller 60 checks the setting of dial 366b to determine which one of strong, regular and light benefit levels corresponding to the second benefit of the benefit composition was selected. At decision step 448, the microcontroller 60 selects one of three predetermined ratios of an amount of the benefit composition to be dosed or dispensed beginning at a first juncture during the fabric enhancement operation to an amount of benefit composition to be dosed beginning at a second juncture during the fabric enhancement operation. In the illustrated embodiment, if the strong level of the second benefit to be provided by the benefit composition is selected, the ratio is 0.67; if the regular level is selected, the ratio is 0.80; and if the light level is selected, the ratio is 0.90.

At step 450, the microcontroller 60 determines a first time period or the initial spray time starting at the first juncture during which the benefit composition is dispensed by multiplying the total dispense time determined during step 444 by the ratio selected in step 448. The microcontroller 60 also determines a second time period or the final spray time starting at the second juncture during which the benefit composition is dispensed by multiplying the total dispense time by (1−ratio). “Ratio” is referred to in the Figures as “DR.”

For example, if the user selects via the dial 366a the regular benefit level for the first benefit and selects via the dial 366b the strong benefit level for the second benefit, see FIG. 10A, the microcontroller 60 determines the first time period by multiplying 240 seconds by 0.67, which is equal to 161 seconds. The microcontroller 60 also determines the second time period by multiplying 240 seconds by 0.33=(1-0.67), which is equal to 79 seconds. Hence, starting at a first juncture, the microcontroller 60 initiates the dispensing of the benefit composition for 161 seconds and at the second juncture, the microcontroller 60 initiates the dispensing of the benefit composition for 79 seconds. The first and second junctures or starting points may be predefined and incorporated into the software instructions executed by the microcontroller 60. For example, the first juncture may correspond to the start time of the fabric enhancement operation, while the second juncture may correspond to the final ⅓ of the fabric enhancement operation. The user may input via the module 266e the total time period for the fabric enhancement operation. For example, if the total time period entered via module 266e equals 100 minutes, then the second juncture would begin 67 minutes into the operation. Hence, the microcontroller 60 will cause the benefit composition to be dispensed for 161 seconds starting when the fabric enhancement operation cycle is initiated and for 79 seconds 67 minutes into the cycle. The user may activate a start key 266b to indicate to the microcontroller 60 that the fabric enhancement operation has begun. If the controller which effects the steps set out in FIG. 10 also operates the structure within the fabric enhancement apparatus 110, it will inherently know the start time for the fabric enhancement operation.

Referring to FIG. 11, a flow chart illustrates a process 460 in accordance with a fourth embodiment of the present invention for selecting at least one dosage amount for applying a benefit composition during a fabric enhancement operation, i.e., a drying, tumbling or washing operation. The at least one dosage amount is selected based upon a user selecting a desired one of two or more load sizes, i.e., the quantity of one or more fabric articles to be processed during the fabric enhancement operation, and a desired one of two or more levels of a benefit to be provided by the benefit composition. The benefit may comprise one or more of softness enhancement, color protection, whiteness protection, stain repellency, scent enhancement, static enhancement, bacterial reduction and wrinkle reduction. The benefit composition may be dispensed via the nozzle 24 provided, for example, in unit 10 illustrated in FIGS. 1-6, or nozzle 24 provided in dispensing apparatus 100 illustrated in FIG. 7. The microcontroller 60 causes the benefit composition to be dispensed at desired times during a fabric enhancement operation by generating appropriate pulse-width modulated (PWM) signals to the pump motor 32 via the conductor 72. The process 460 may be implemented by software instructions executed on the microcontroller 60.

Prior to the fabric enhancement operation, a user dials in the load size to be processed during the fabric enhancement operation effected by, for example, the apparatus 110 illustrated in FIG. 7. In the illustrated embodiment, the user dials in the load size by selecting one of a large load, a regular load and small load via dial 466a on input device 466 illustrated in FIG. 11A, where like reference numerals indicate like elements. The user also dials in a desired benefit level via dial 466b on the input device 466. The input device 466 may be incorporated into the enclosure 50 of the unit 10 of FIGS. 1-6 as a substitute for device 66, or into the control panel 112 of the apparatus 110 of FIG. 7 as a substitute for device 166. The dials 466a and 466b generate appropriate analog or digital signals to the microcontroller 60 corresponding to the selected load size and benefit level.

At step 462, the microcontroller 60 checks the setting of dial 466a to determine which load size was selected. At decision step 464, the microcontroller 60 determines an amount of benefit composition to be dispensed via the nozzle 24 during the fabric enhancement operation based on the selected load size. If the large load size is selected, then the controller determines that 100 milliliters of benefit composition will be dispensed during the fabric enhancement operation. If the regular load size is selected, then the microcontroller 60 determines that 80 milliliters of benefit composition will be dispensed, and if the small load size is selected, then the microcontroller 60 determines that 50 milliliters of benefit composition will be dispensed. It may be presumed that the flow rate through the nozzle 24 is constant. Based on this presumption, the software instructions may be written such that the microcontroller 60 determines each benefit composition amount to be dispensed in terms of a total time period for dispensing the benefit composition. For example, a total dispense time of 300 seconds may correspond to 100 milliliters of the benefit composition being dispensed; 240 seconds may correspond to 80 milliliters of the benefit composition being dispensed; and 150 seconds may correspond to 50 milliliters of the benefit composition being dispensed.

At step 467, the microcontroller 60 checks the setting of dial 466b to determine which one of strong, regular and light benefit levels corresponding to the benefit of the benefit composition was selected. At decision step 468, the microcontroller 60 selects one of three predetermined ratios of an amount of the benefit composition to be dosed or dispensed beginning at a first juncture during the fabric enhancement operation to an amount of benefit composition to be dosed beginning at a second juncture during the fabric enhancement operation. In the illustrated embodiment, if the strong level of the benefit to be provided by the benefit composition is selected, the ratio is 0.67; if the regular level is selected, the ratio is 0.80; and if the light level is selected, the ratio is 0.90.

At step 470, the microcontroller 60 determines a first time period or the initial spray time starting at the first juncture during which the benefit composition is dispensed by multiplying the total dispense time determined during step 464 by the ratio selected in step 468. The microcontroller 60 also determines a second time period or final spray time starting at the second juncture during which the benefit composition is dispensed by multiplying the total dispense time by (1−ratio).

The first and second junctures or starting points may be predefined and incorporated into the software instructions executed by the microcontroller 60. For example, the first juncture may correspond to the start time of the fabric enhancement operation, while the second juncture may correspond to the final ⅓ of the fabric enhancement operation. The user may input via the module 266e the total time period for the fabric enhancement operation. For example, if the total time period entered via module 266e equals 100 minutes, then the second juncture would begin 67 minutes into the fabric enhancement operation. The user may activate a start key 266b to indicate to the microcontroller 60 that the fabric enhancement operation has begun. If the controller which effects the steps set out in FIG. 11 also operates the structure within the fabric enhancement apparatus 110, it will inherently know the start time for the fabric enhancement operation.

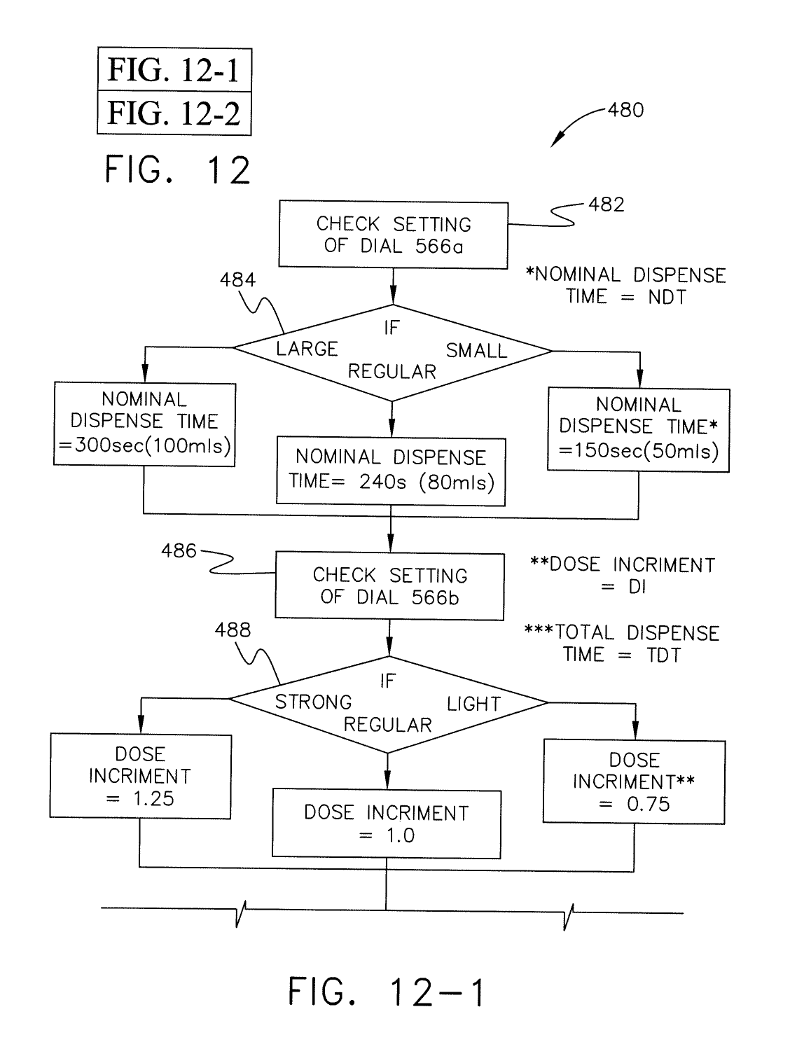

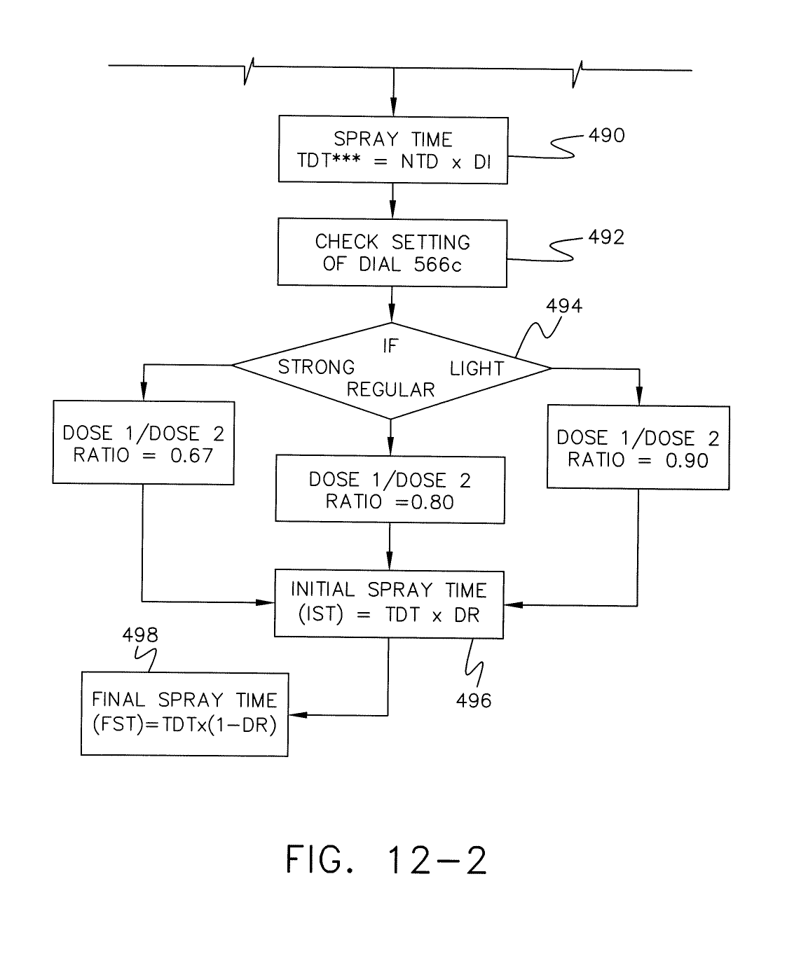

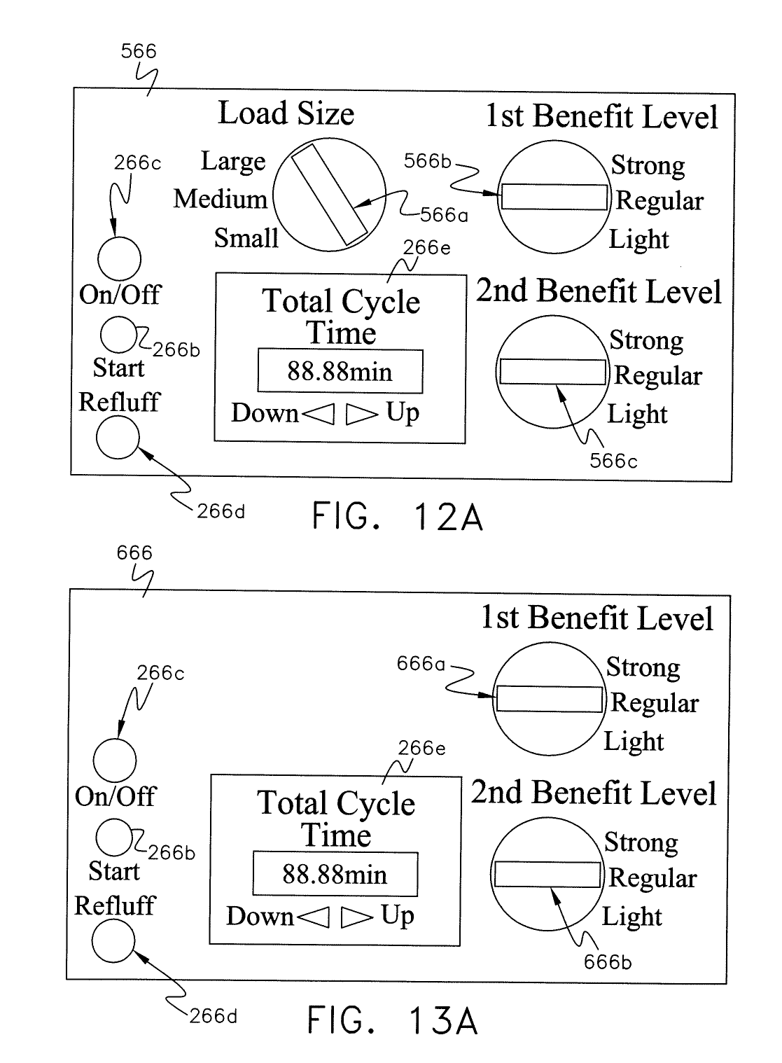

Referring to FIG. 12, a flow chart illustrates a process 480 in accordance with a fifth embodiment of the present invention for selecting at least one dosage amount for applying a benefit composition during a fabric enhancement operation, i.e., a drying, tumbling or washing operation. The at least one dosage amount is selected based upon a user selecting a desired one of two or more load sizes, i.e., the quantity of one or more fabric articles to be process during the fabric enhancement operation, a desired one of two or more levels of a first benefit to be provided by the benefit composition, and a desired one of two or more levels of a second benefit to be provided by the benefit composition. The first benefit may comprise one or more of softness enhancement, color protection, whiteness protection and stain repellency. Typically, these benefits are accentuated if the benefit composition is dispensed during an initial segment of a fabric enhancement operation. The second benefit may comprise one or more of scent enhancement, static enhancement, bacterial reduction and wrinkle reduction. Typically, these benefits are accentuated if the benefit composition is dispensed during a final segment of the fabric enhancement operation. Hence, in this embodiment, it is presumed that the benefit composition is capable of provided at least one of a first benefit and at least one of a second benefit. The benefit composition may be dispensed via the nozzle 24 provided, for example, in unit 10 illustrated in FIGS. 1-6, or nozzle 24 provided in dispensing apparatus 100 illustrated in FIG. 7. The microcontroller 60 causes the benefit composition to be dispensed at desired times during a fabric enhancement operation by generating appropriate pulse-width modulated (PWM) signals to the pump motor 32 via the conductor 72. The process 480 may be implemented by software instructions executed on the microcontroller 60.

Prior to the fabric enhancement operation, a user dials in the load size to be processed during the fabric enhancement operation effected by, for example, the apparatus 110 illustrated in FIG. 7. In the illustrated embodiment, the user dials in the load size by selecting one of a large load, a regular load and small load via dial 566a on input device 566 illustrated in FIG. 12A, where like reference numerals indicate like elements. The user also dials in a desired first benefit level via dial 566b on the input device 566 and a desired second benefit level via dial 566c on the input device 566. The input device 566 may be incorporated into the enclosure 50 of the unit 10 of FIGS. 1-6 as a substitute for device 66, or into the control panel 112 of the apparatus 110 of FIG. 7 as a substitute for device 166. The dials 566a-566c generate appropriate analog or digital signals to the microcontroller 60 corresponding to the selected load size and benefit levels.

At step 482, the microcontroller 60 checks the setting of dial 566a to determine which load size was selected. At decision step 484, the microcontroller 60 determines a nominal time for the benefit composition to be dispensed via the nozzle 24 during the fabric enhancement operation based on the selected load size. If the large load size is selected, then the controller determines that the nominal dispense time is 300 seconds. If the regular load size is selected, then the microcontroller 60 determines that the nominal dispense time is 240 seconds, and if the small load size is selected, then the microcontroller 60 determines that the nominal dispense time is 150 seconds.

At step 486, the microcontroller 60 checks the setting of dial 566b to determine which one of strong, regular and light benefit levels corresponding to the first benefit of the benefit composition was selected. At decision step 488, the microcontroller 60 determines a dose increment based on the selected level corresponding to the first benefit.

In the illustrated embodiment, if the strong level is selected, then the microcontroller 60 determines a dose increment equal to 1.25. If the regular level is selected, then the dose increment is determined to be 1.0 and if the light level is selected, then the dose increment is determined to be 0.75.

At step 490, the controller 60 determines a total dispense time (TDT) during which the benefit composition is dispensed during the fabric enhancement operation. The total dispense time is determined by multiplying the nominal dispense time determined during step 484 by the dose increment determined during step 488.

At step 492, the microcontroller 60 checks the setting of dial 566c to determine which one of strong, regular and light benefit levels corresponding to the second benefit of the benefit composition was selected. At decision step 494, the microcontroller 60 selects one of three predetermined ratios of an amount of the benefit composition to be dosed or dispensed beginning at a first juncture during the fabric enhancement operation to an amount of benefit composition to be dosed beginning at a second juncture during the fabric enhancement operation. In the illustrated embodiment, if the strong level of the second benefit to be provided by the benefit composition is selected, then the ratio is 0.67; if the regular level is selected, then the ratio is 0.80; and if the light level is selected, then the ratio is 0.90.

At step 496, the microcontroller 60 determines a first time period or the initial spray time starting at the first juncture during which the benefit composition is dispensed by multiplying the total dispense time determined during step 490 by the ratio selected in step 494. At step 498, the microcontroller 60 determines a second time period or final spray time starting at the second juncture during which the benefit composition is dispensed by multiplying the total dispense time by (1−ratio).

The first and second junctures or starting points may be predefined and incorporated into the software instructions executed by the microcontroller 60. For example, the first juncture may correspond to the start time of the fabric enhancement operation, while the second juncture may correspond to the final ⅓ of the fabric enhancement operation. The user may input via the module 266e on input device 566 the total time period for the fabric enhancement operation. For example, if the total time period entered via module 266e equals 100 minutes, then the second juncture would begin 67 minutes into the fabric enhancement operation. The user may activate a start key 266b to indicate to the microcontroller 60 that the fabric enhancement operation has begun. If the controller which effects the steps set out in FIG. 12 also operates the structure within the fabric enhancement apparatus 110, it will inherently know the start time for the fabric enhancement operation.

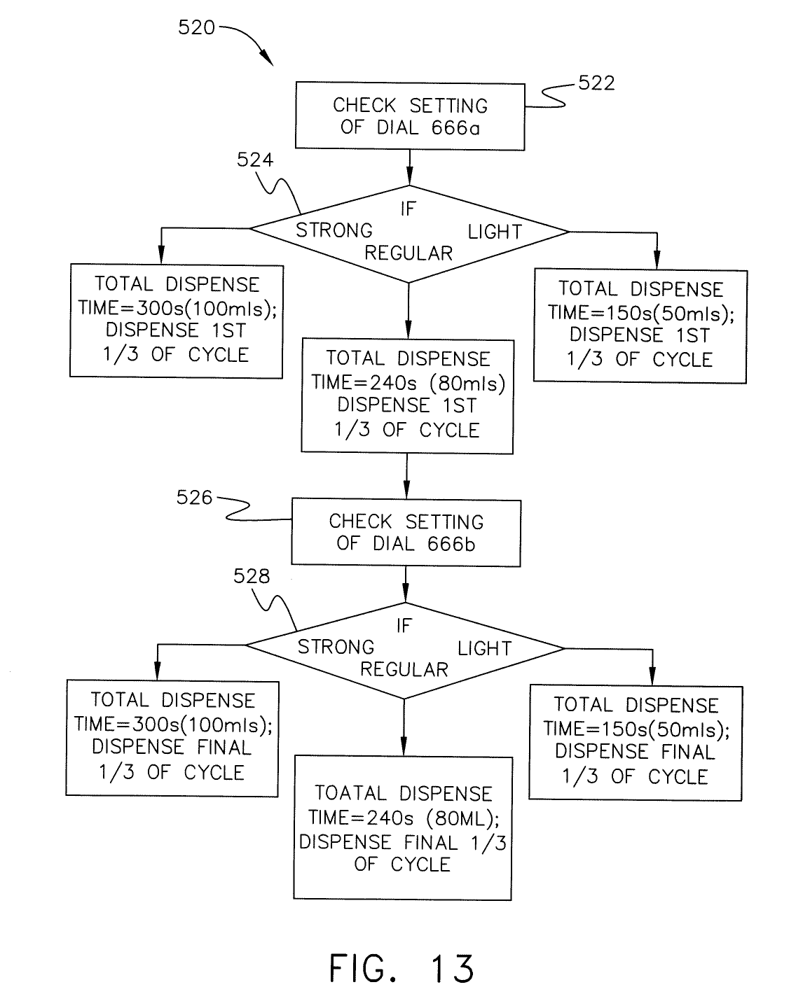

Referring to FIG. 13, a flow chart illustrates a process 520 in accordance with a sixth embodiment of the present invention for applying or dispensing first and second separate benefit compositions during a fabric enhancement operation, i.e., a drying, tumbling or washing operation. A dosage amount is selected for the first benefit composition based upon a user selecting a desired one of two or more levels of a first benefit to be provided by the first benefit composition and a dosage amount is selected for the second benefit composition based upon a user selecting a desired one of two or more levels of a second benefit to be provided by the second benefit composition. The first benefit provided by the first benefit composition may comprise one or more of softness enhancement, color protection, whiteness protection and stain repellency. Typically, these benefits are accentuated if the benefit composition is dispensed during an initial segment of a fabric enhancement operation. The second benefit provided by the second benefit composition may comprise one or more of scent enhancement, static enhancement, bacterial reduction and wrinkle reduction. Typically, these benefits are accentuated if the benefit composition is dispensed during a final segment of the fabric enhancement operation. While not shown in the drawings, separate first and second high voltage power supplies, similar to supply 28 illustrated in FIG. 5, first and second reservoirs, similar to reservoir 26 illustrated in FIG. 5, first and second pump/motor combinations, similar to the pump/motor combination illustrated in FIG. 5, and first and second nozzles, similar to nozzle 24 illustrated in FIG. 5, may be provided. Appropriate power sources, power supplies, and DACs, may also be provided for driving the first and second pump motors. It is contemplated that a single microcontroller 60 or first and second separate microcontrollers (not shown) may also be provided for generating appropriate pulse-width modulated (PWM) signals to the first and second pump motors. The process 520 may be implemented by software instructions executed on the microcontroller 60 or first and second microprocessors.

Prior to the fabric enhancement operation, a user dials in a desired first benefit level corresponding to the first benefit composition via dial 666a on an input device 666 and a desired second benefit level corresponding to the second benefit composition via dial 666b on input device 666, see FIG. 13A, where like elements are referenced by like numerals. The input device 666 may be incorporated into the enclosure 50 of the unit 10 of FIGS. 1-6 as a substitute for device 66, or into the control panel 112 of the apparatus 110 of FIG. 7 as a substitute for device 166.

In the illustrated embodiment, a user rotates dial 666a to a desired one of a strong, regular or light setting corresponding to a strong, regular or light first benefit level to be provided by the first benefit composition to be dispensed onto at least one fabric article during the fabric enhancement operation. The dial 666a generates an appropriate analog or digital signal to the microcontroller 60 corresponding to the selected benefit level. The user also rotates dial 666b to a desired one of a strong, regular or light setting corresponding to a strong, regular or light second benefit level to be provided by the second benefit composition to be dispensed onto at least one fabric article during the fabric enhancement operation. The dial 666b generates an appropriate analog or digital signal to the microcontroller 60 corresponding to the selected benefit level.

At step 522, the microcontroller 60 checks the setting of dial 666a to determine which one of strong, regular and light benefit levels corresponding to the first benefit of the first benefit composition was selected. At decision step 524, the microcontroller 60 determines an amount of benefit composition to be dispensed and a start time for dispensing via the corresponding first nozzle during the fabric enhancement operation based on the selected level of the first benefit to be provided by the first benefit composition. If the strong benefit level is selected, then the controller determines that 100 milliliters of benefit composition will be dispensed during a first ⅓ of the fabric enhancement operation cycle. If the regular benefit level is selected, the microcontroller 60 determines that 80 milliliters of benefit composition will be dispensed during the first ⅓ of the fabric enhancement operation cycle, and if the light benefit level is selected, the microcontroller 60 determines that 50 milliliters of benefit composition will be dispensed during the first ⅓ of the fabric enhancement operation cycle. It may be presumed that the flow rate through the first nozzle is constant. Based on this presumption, the software instructions may be written such that the microcontroller 60 determines each benefit composition amount to be dispensed in terms of a total time period for dispensing the benefit composition. For example, a total dispense time of 300 seconds may correspond to 100 milliliters of the benefit composition being dispensed; 240 seconds may correspond to 80 milliliters of the benefit composition being dispensed; and 150 seconds may correspond to 50 milliliters of the benefit composition being dispensed.

At step 526, the microcontroller 60 checks the setting of dial 666b to determine which one of strong, regular and light benefit levels corresponding to the second benefit of the second benefit composition was selected. At decision step 528, the microcontroller 60 determines an amount of benefit composition to be dispensed and a start time for dispensing via the corresponding second nozzle during the fabric enhancement operation based on the selected level of the second benefit to be provided by the second benefit composition. If the strong benefit level is selected, then the controller determines that 100 milliliters of benefit composition will be dispensed during a final ⅓ of the fabric enhancement operation cycle. If the regular benefit level is selected, the microcontroller 60 determines that 80 milliliters of benefit composition will be dispensed during the final ⅓ of the fabric enhancement operation cycle, and if the light benefit level is selected, the microcontroller 60 determines that 50 milliliters of benefit composition will be dispensed during the final ⅓ of the fabric enhancement operation cycle.

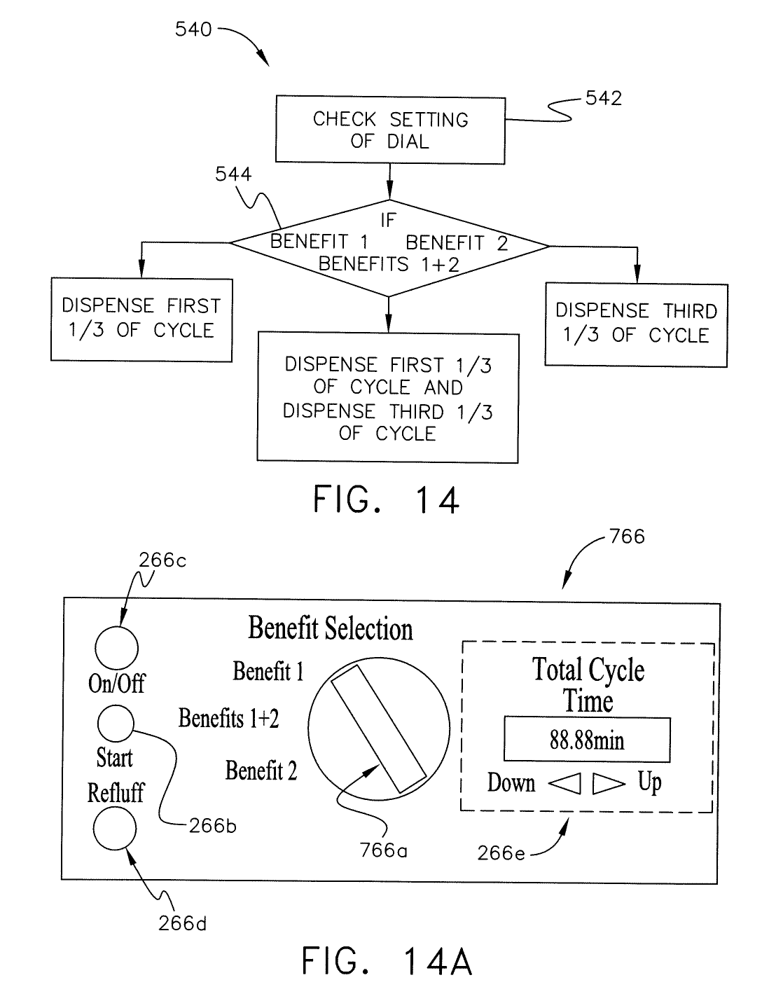

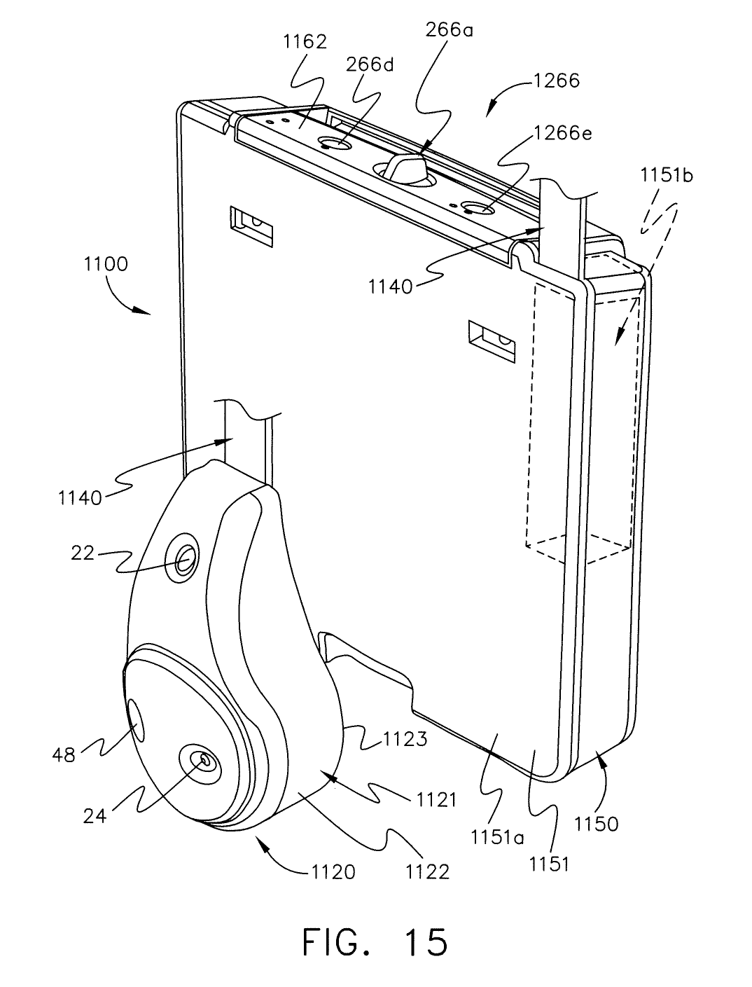

Referring to FIG. 14, a flow chart illustrates a process 540 in accordance with a seventh embodiment of the present invention for applying the benefit composition to a fabric article during a fabric enhancement operation, i.e., a drying, tumbling or washing operation. The benefit composition may be dispensed via the nozzle 24 provided, for example, in unit 10 illustrated in FIGS. 1-6, or nozzle 24 provided in dispensing apparatus 100 illustrated in FIG. 7. The microcontroller 60 causes the benefit composition to be dispensed at desired times during a fabric enhancement operation by generating appropriate pulse-width modulated (PWM) signals to the pump motor 32 via the conductor 72. The process 540 may be implemented by software instructions executed on the microcontroller 60.

Prior to the fabric enhancement operation, a user selects at least one of first and second benefits capable of being provided by the benefit composition via dial 766a on input device 766, see FIG. 14A, where like reference numeral indicate like elements. The first benefit may comprise one or more of softness enhancement, color protection, whiteness protection and stain repellency. Typically, these benefits are accentuated if the benefit composition is dispensed during an initial segment of a fabric enhancement operation. The second benefit may comprise one or more of scent enhancement, static enhancement, bacterial reduction and wrinkle reduction. Typically, these benefits are accentuated if the benefit composition is dispensed during a final segment of the fabric enhancement operation. Hence, in this embodiment, it is presumed that the benefit composition is capable of provided at least one first benefit and at least one second benefit.

At step 542, the microcontroller 60 checks the setting of dial 766a to determine if the first benefit (Benefit 1 in FIG. 14A) was selected, the second benefit (Benefit 2 in FIG. 14A) was selected, or both the first and second benefits were selected. At decision step 544, the microcontroller 60 determines a time within the fabric enhancement operation cycle for initiating the dispensing of the benefit composition. If the first benefit is selected, then the controller determines that the benefit composition will be dispensed during the first ⅓ of the cycle, which may correspond to an optimum time value of 0. If the fabric enhancement operation is a drying cycle, the first ⅓ of that cycle may comprise a warm-up segment. If the second benefit is selected, the microcontroller 60 determines that the benefit composition will be dispensed during the final ⅓ of the cycle, which may correspond to an optimum time value of 0.67. If the fabric enhancement operation comprises a drying cycle, the final ⅓ of that cycle may comprise a cool-down segment. If both the first and second benefits are selected, then the controller determines that a first portion of the benefit composition will be dispensed during the first ⅓ of the cycle, corresponding to a first optimum time value of 0, while a remaining portion of the benefit composition is dispensed during a final ⅓ of the cycle, corresponding to a second optimum time value of 0.67. The first and second portions may be equal or unequal to one another.

If only the first or the second benefit is selected, then the timing for applying the benefit composition may be effected in accordance with the process 300 illustrated in FIG. 9A. Initially, the user inputs via the module 266e on the input device 766 a total fabric enhancement time period, e.g., a total drying cycle time. The microcontroller 60 stores that time period in memory as value TM1. A user may activate a start key 266b on the input device 766 to indicate to the microcontroller 60 that the fabric enhancement operation has begun. In step 320, the microcontroller 60 determines if the elapsed time has exceeded a time threshold, which is determined by multiplying the value TM1 by the optimum time value determined during process 540, discussed above. The optimum time value is designed by “K” in FIG. 9A. If the benefit composition is to be dispensed during the initial ⅓ of the cycle, then the optimum time value is 0; and if the benefit composition is to be dispensed during the final ⅓ of the cycle, then the optimum time value is 0.67. If the elapsed time has not exceeded the time threshold, then the microprocessor 60 returns to step 320. If the elapsed time has exceeded the time threshold, then the microprocessor proceeds to step 322, resulting in the microcontroller 66 initiating the dispensing of the benefit composition. If only the first or the second benefit is selected, the composition may be dispensed for a single predefined period of time, e.g., 80 seconds.

If both the first and second benefits are selected, the composition may be dispensed for a predefined first time period during the first ⅓ of the cycle and for a predefined second time period during the final ⅓ of the cycle. The first and second predefined periods of time may be equal or unequal to one another. For example, the first and second time periods may each equal 40 seconds.

If both benefits are selected, then the timing for applying the benefit composition may be effected as follows. Initially, the microcontroller 60 may determine if the elapsed time has exceeded a first time threshold, which is determined by multiplying the value TM1, noted above, by the first optimum time value (0) determined during process 540, discussed above. Hence, once an operator has activated the start key 266b, the microcontroller 60 will cause the benefit composition to be dispensed for the first time period. The microcontroller will later determine if the elapsed time has exceeded a second time threshold, which is determined by multiplying the value TM1 by the second optimum time value (0.67) determined during process 540. Once the elapsed time has exceeded the second time threshold, then the microprocessor 60 initiates the dispensing of the benefit composition for a second time for the second time period.

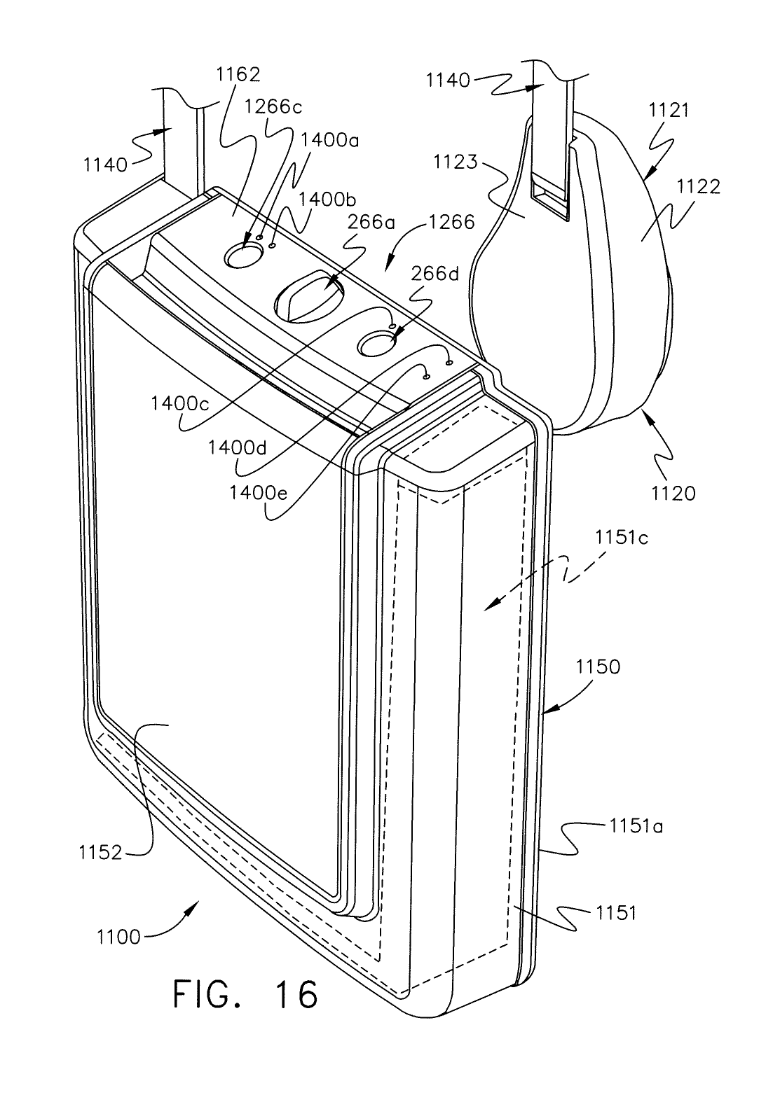

In FIGS. 15-18, where like reference numerals indicate like elements, a benefit composition dispensing apparatus 1100 constructed in accordance with a third embodiment of the present invention is illustrated. The apparatus 1100 comprises two enclosures or housings 1120 and 1150. Enclosure 1120 defines an “inner housing” located in an interior of a fabric enhancement apparatus such as a fabric article drying appliance, e.g., a clothes dryer (not shown in FIGS. 15-18), while the enclosure 1150 defines an “outer housing” located outside of the fabric article drying appliance. The fabric enhancement apparatus may also comprise a laundry apparatus or a laundry and drying apparatus. The enclosure 1150 may be mounted on an exterior surface of the fabric enhancement apparatus door (not shown), such as by pressure sensitive, thermally stable adhesive foam strips (not shown). Alternatively, the enclosure 1150 may be mounted on any other exterior surface of the fabric enhancement apparatus, non-limiting examples of which include: side walls, top walls, an outer surface of a top-opening lid, and the like. The enclosure 1150 may also be mounted on a wall or other household structure that is separate from the fabric enhancement apparatus. Furthermore, the enclosure 1120 may be mounted, such as by pressure sensitive, thermally stable adhesive foam strips (not shown), on any interior surface of the fabric enhancement apparatus, examples of which include, but are not limited to: the interior surface of the door, a drum of the apparatus, the back wall, the inner surface of a top-opening lid, and the like.

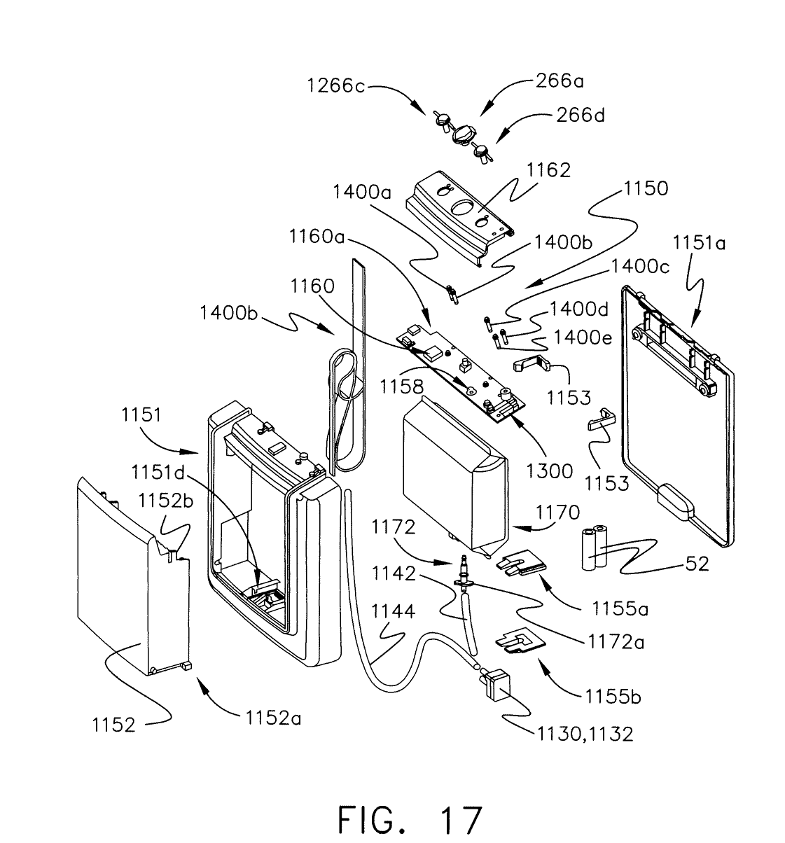

As illustrated in FIGS. 15 and 16, the inner housing enclosure 1120 comprises a main body 1121 comprising an integral front/side main section 1122 and a back plate section 1123 secured to the main section 1122 via screws, adhesive, snap-fit elements or the like. The sections 1122 and 1123 are preferably molded from a polymeric material. Housed within the main body 1121 are the following elements: a discharge nozzle 24; a door sensor 22 for sensing ambient light when the door of the fabric enhancement apparatus is open such that the sensor 22 is exposed to ambient light; a motion sensor 36 (contained within the main body 1121 and not visible from outside the main body 1121); a humidity sensor 46 (not shown in FIGS. 15-17); and a temperature sensor 48. In this embodiment, the nozzle 24 is not combined with a high voltage power supply. The nozzle 24 functions as a fluid atomizing nozzle so as to generate a pressurized spray. One suitable example of a fluid-atomizing nozzle is the pressure swirl atomizing nozzle noted above from Seaquist Dispensing of Cary, Ill., which nozzle is sold as Model No. DU-3813.

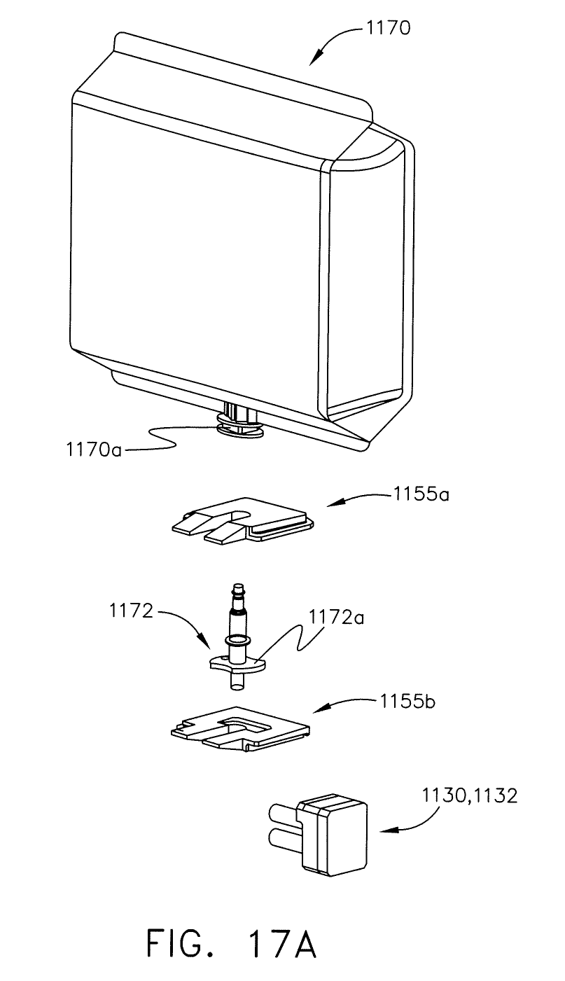

The enclosure 1150 comprises a main body 1151 having a back wall 1151a, a first inner compartment 1151b, see FIG. 15, for storing varying lengths of unused cable 1140, to be described below, and a second compartment 1151c, see FIG. 16, for storing a fluid pump 1130, a motor 1132 for driving the pump 1130, batteries 52, a tube 1142 (to be discussed below) and a portion of a tube 1144 (to be discussed below). The enclosure 1150 further comprises a cassette door 1152 pivotably coupled to the main body 1151 such as by pins 1152a (only one of which is illustrated in FIG. 17), a printed circuit board 1160a and a face plate 1162. The printed circuit board 1160a is housed between the main body 1151 and the face plate 1162. The face plate 1162 is coupled to the main body 1151 via screws, adhesive, snap-fit elements, or like coupling elements. The pivotable door 1152 comprises a pocket 1152b for receiving a fluid reservoir defined by a removable container 1170 filled with a benefit composition, which composition may comprise any one of the benefit compositions discussed in this document or the documents noted herein. The container 1170 may be formed from a polymeric material, paper, foil, a combination of these materials or a like material. The door 1152 is releasably held in a closed position within the main body 1151 via first and second flex arms 1153, which are coupled to the main body 1151.

Extending through corresponding openings in the face plate 1162 are an ON-OFF switch 1266c, a “refluff” key or switch 266d, and a dial 266a, which may comprise a potentiometer, which a user rotates to dial in a desired one of a strong, regular or light setting corresponding to a strong, regular or light benefit level to be provided by a benefit composition to at least one fabric article during a fabric enhancement operation. The face plate 1162, ON-OFF switch 1266c, refluff key 266d and dial 266a define the input device 1266 illustrated in FIG. 8B.

The cable 1140 is coupled to and extends between the enclosures 1120 and 1150. The cable 1140 may run along the inner surface of the fabric enhancement apparatus door, over the top of the door, and down the exterior surface of the door. Any unused length of the cable 1140 can be manually inserted into the first compartment 1151b for storage.

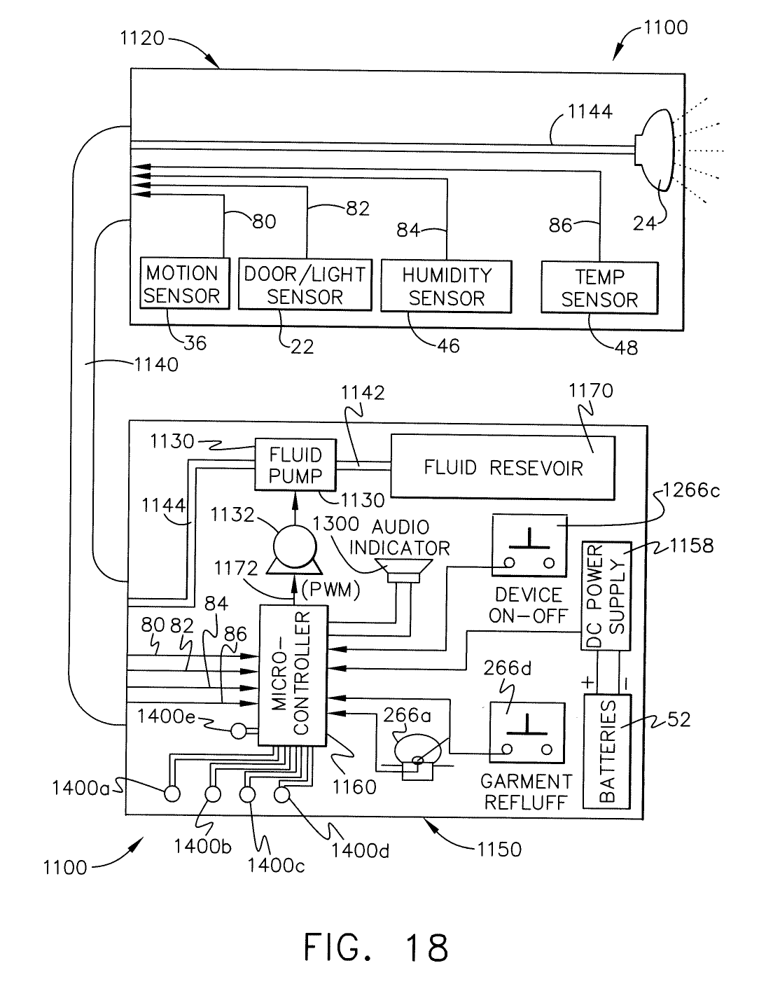

The cable 1140 carries benefit composition from the fluid pump 1130 in the outer enclosure 1150 to the nozzle 24 in the inner enclosure 1120, see FIG. 18, and electrical signals from the sensors 36, 22, 46 and 48 mounted in the inner enclosure 1120 to a microcontroller 1160 (see FIGS. 17 and 18) mounted to the printed circuit board 1160a in the outer enclosure 1150. The signal generated by the motion sensor 36 travels over conductor 80, the signal generated by the door sensor 22 travels over conductor 82, the signal generated by the humidity sensor 46 travels over conductor 84 and the signal generated by the temperature sensor 48 travels over conductor 86, see FIG. 5. The conductors 80, 82, 84 and 86 extend through the cable 1140.

A first fitment 1172 is mounted to the main body 1151 via first and second mounting shelves 1155a and 1155b, see FIGS. 17 and 17A, and is coupled to the tube or channel 1142 (not shown in FIG. 17A), which, in turn, is coupled to the pump 1130. The first and second shelves 1155a and 1155b are positioned on opposing sides of a flange 1172a of the first fitment 1172 and are snap fit, adhesively secured or bolted together so as to encompass the flange 1172a. The assembly comprising the shelves 1155a and 1155b and fitment 1172 is mounted to the main body 1151 such that the shelves 1155a and 1155b are received within a slot 1151d defined in the main body 1151. The fitment 1172 is inserted into a second fitment 1170a forming part of the fluid container 1170 when the door 1152 is pivoted to its closed position and functions to pierce or otherwise penetrate the container 1170 so as to provide a pathway for the benefit composition to travel from the container 1170 to the tube 1142. From the tube 1142, the benefit composition travels to the inlet of the pump 1130, after which the composition is pressurized and carried via the tube or channel 1144 (shown in FIG. 17), which extends through the cable 1140, to the discharge nozzle 24, where the benefit composition is discharged. In the illustrated embodiment, the pump 1130 and the motor 1132 comprises a single assembly, namely, a piezoelectric pump, one of which is commercially available from Par Technologies, LLC, under the product designation LPD-30S.

The types of control signals used to control the electric motor 1132 can vary according to the design requirements of the apparatus 1100, and such signals will travel to the motor 1132 via an electrical conductor 1172. In the illustrated embodiment, the electrical signal traveling along conductor 1172 comprises a pulse-width modulated (PWM) signal controlled by the microcontroller 1160. Of course, such a pulse-width modulated signal can also be generated by any appropriate controller or processor, or appropriate discrete logic.

As noted above, the enclosure 1150 comprises a second compartment 1151c for storing batteries 52, which may comprise two AA batteries. In the illustrated embodiment, the batteries 52 define a power source, which provide a DC voltage to a DC power supply 1158, see FIG. 18. An example DC power supply comprises an integrated circuit chip commercially available from Maxim Integrated Products under the product designation “MAX1724EZK50-T.” The DC power supply 1158 provides an output voltage to the microcontroller 1160.

A suitable microcontroller 1160 is a microprocessor manufactured by Atmel Corporation and sold under the product designation Atmega48-16AI. Alternatively, the microcontroller 1160 may comprise a microprocessor manufactured by Atmel Corporation and sold under the product designation Atmega48-16AJ. Of course, other microcontrollers, microprocessors, controllers, or processors made by different manufacturers, or discrete digital logic could alternatively be used.

The microcontroller 1160 includes on-board memory and input and output lines for analog and digital signals. The microcontroller 1160 also has a serial port that can be interfaced to an optional programmer interface using an RS-232 communications link. As noted above, the ON-OFF switch 1266c, and the refluff key 266d are coupled to the microcontroller 1160, see FIG. 18. As also noted above, the motion sensor 36, door sensor 22, humidity sensor 46 and temperature sensor 48 generate signals to the microcontroller 1160. As further noted above, the microcontroller 60 generates a pulse-width modulated (PWM) signal to the pump motor 1132 via the conductor 1172. An audio indicator 1300 is further coupled to the microcontroller 1160 and functions to indicate that a drying cycle has been completed, clothes have been treated with the benefit composition, an error occurred during the benefit composition dosing cycle or the benefit composition dispensing apparatus is out of fluid. The audio indicator 1300 is mounted to the printed circuit board 1160, see FIG. 17.

Further coupled to the microcontroller 1160 are first, second, third, fourth and fifth light emitting diodes 1400a-1400e, see FIGS. 16-18. The diodes are coupled to the face plate 1162 so as to be visible to an operator when actuated, see FIG. 16. The first diode 1400a is actuated by the microcontroller 1160 when the apparatus 1100 is activated via the ON-OFF switch 1266c. The second diode 1400b is actuated by the microcontroller 1160 when the pump 1130 is pumping benefit composition to the nozzle 24. The third diode 1400c is actuated by the microcontroller 1160 when the refluff key 266d has been activated. The fourth diode 1400d is actuated by the microcontroller 1160 when the spraying operation has been completed for the corresponding fabric enhancement operation cycle. The fifth diode 1400e is actuated by the microcontroller 1160 to generate a warning signal when the container is out of fluid, or the fabric enhancement cycle has been interrupted, which latter event may be detected via the door sensor 22 sensing light or the motion sensor 36 sensing no motion. The microcontroller 1160 may sense that the container 1170 is out of fluid by sensing a change in the current drawn by the pump motor 1132.

In the embodiment illustrated in FIGS. 15-18, the microcontroller 1160 causes the benefit composition to be dispensed into a drying apparatus after both of the following events have occurred: the temperature of the interior of a drum forming part of the drying apparatus has increased above a first predefined temperature as sensed by the sensor 48, and, subsequently, the temperature of the interior of the drum has dropped below a second predefined temperature, which is lower than the first predefined temperature. In this embodiment, the benefit composition is dispensed during the cool-down portion of a drying cycle, which typically occurs within the last ⅓ of the cycle. It is further contemplated that a first portion (e.g., 50%) of the benefit composition may be dispensed after the temperature of the interior of a drum forming part of the drying apparatus has increased above a first predefined temperature as sensed by the sensor 48, and, subsequently, a remaining portion (e.g., 50%) of the benefit composition may be dispensed after the temperature of the interior of the drum has dropped below a second predefined temperature, which is lower than the first predefined temperature.

It is also contemplated that the input device 1266 in the FIG. 15 embodiment may comprise the input device 266 illustrated in FIG. 8A, and the microcontroller 1160 may function in accordance with the process 400 illustrated in FIG. 8 or the processes 420 and 300 illustrated in FIGS. 9 and 9A. It is further contemplated that the input device 1266 in the FIG. 15 embodiment may comprise the input device 366 illustrated in FIG. 10A, the input device 466 illustrated in FIG. 11A, the input device 566 illustrated in FIG. 12A, the input device 666 illustrated in FIG. 13A or the input device 766 illustrated in FIG. 14A. It is additionally contemplated that the microcontroller 1160 may function in accordance with the process 440 illustrated in FIG. 10, the process 460 illustrated in FIG. 11, the process 480 illustrated in FIG. 12, the process 520 illustrated in FIG. 13, or the process 540 illustrated in FIG. 14.

It is noted that the lettered indicia provided on each of the input devices of FIGS. 8A, 8B, 10A, 11A, 12A, 13A and 14A may be replaced by non-verbal visual cues, which is information that assists in communicating the setting or function associated with the corresponding dial, knob, key, module or button on those input devices. The information may be symbols and/or pictures. For example, a large load size may be indicated by a visual representation, i.e., a picture, of a large basket of clothes; a small load size may be indicated by a visual representation, i.e., a picture, of a small basket of clothes; and a regular load size may be indicated by a visual representation, i.e., a picture, of a basket of clothes having an intermediate size. It is also contemplated that three clothes hangers may indicate a large load size, two clothes hangers may indicate a regular load size and a single clothes hanger may indicate a small load size. It is still further contemplated that three shirts on a clothes line may indicate a large load size, two shirts on a clothes line may indicate a regular load size and a single shirt on a clothes line may indicate a small load size.

It is further contemplated that a benefit composition dispensing apparatus constructed in accordance with the present invention may comprise a “single-housing” stand-alone unit similar to the one disclosed in patent application U.S. Ser. No. 10/762,152, entitled “Volatile Material Delivery Method.” In such an embodiment, the apparatus comprises a single housing in which all electrical, electronic and mechanical components are housed. For example, such a single-housing stand-alone unit may comprise the components illustrated in FIG. 5 or the components illustrated in FIG. 10 of this application, which components are all housed within a single housing. The single housing is adapted to be positioned within an apparatus for effecting a fabric enhancement operation.

### Benefit Compositions

It is believed that benefit compositions which provide one or more of the following benefits—softness enhancement, color protection, whiteness protection, and stain repellency—may perform best if applied during an initial portion of a fabric enhancement operation. An example of such a benefit composition is the following softness formula:

| Chemical name | Supplier | Function | % Weight |
|---|---|---|---|
| Di-tallowoylethanolester | Akzo Nobel | Softening | 6.5% |
| dimethylammonium chloride | | active | |
| Sucrose fatty ester | PG Chemicals | Softening | 2% |
| | | active | |
| Propylene glycol n-butyl ether | Dow Chemicals | Solvent | 2% |
| 1,2 propanediol | PG Chemicals | Solvent | 4% |
| CaCl₂•6H₂O | Qingdao Zhouji | Viscosity | 0.2% |
| | Chemicals | control | |
| Water | — | Filler | Balance |
| | | TOTAL | 100% |

It is believed that benefit compositions which provide one or more of the following benefits—scent enhancement, static reduction, bacterial reduction and wrinkle reduction—may perform best if applied during the final portion of a fabric enhancement operation. An example of such a benefit composition is the following dewrinkling/freshness formula:

| Chemical name | Supplier | Function | % Weight |
|---|---|---|---|
| Silicone copolyol | Dow Corning | Superwetter/lubricant | 2% |
| 1,2 propanediol | PG Chemicals | Solvent | 10% |
| Glycerol | PG Chemicals | Humectant | 1% |
| Perfume | Givaudan | Freshness | 0.2% |
| Water | — | Filler | Balance |
| | | TOTAL | 100% |

Some benefit compositions are capable of provided at least one of a first benefit such as softness enhancement, color protection, whiteness protection and stain repellency, as well as at least one of a second benefit, such as scent enhancement, static enhancement, bacterial reduction and wrinkle reduction. An example of such a benefit composition is the following softness/freshness/dewrinkling formula:

| Chemical name | Supplier | Function | % Weight |
|---|---|---|---|
| Di-tallowoylethanolester | Akzo Nobel | Softening | 6.5% |
| dimethylammonium chloride | | active | |
| Sucrose fatty ester | PG Chemicals | Softening | 2% |
| | | active | |
| Propylene glycol n-butyl ether | Dow | Solvent | 2% |
| | Chemicals | | |
| Silicone copolyol | Dow Corning | Superwetter/ | 2% |
| | | lubricant | |
| 1,2 propanediol | PG Chemicals | Solvent | 5% |
| Glycerol | PG Chemicals | Humectant | 1% |
| Perfume | Givaudan | Freshness | 0.35% |
| Water | — | Filler | Balance |
| | | TOTAL | 100% |

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention. All documents cited herein are in relevant part, incorporated by reference. The citation of any document is not to be construed as an admission that it is prior art with respect to the present invention.

What is claimed is:

1. A process for applying a benefit composition to at least one fabric article during a fabric enhancement operation comprising the steps of:
selecting via an input device a desired one of two or more levels of a benefit to be provided by said benefit composition to said at least one fabric article; and
selecting at least one dosage amount for said benefit composition based on said selected benefit level.

2. A process as set forth in claim 1, wherein said fabric enhancement operation comprises a fabric drying operation.

3. A process as set forth in claim 1, wherein said fabric enhancement operation comprises a fabric tumbling operation.

4. A process as set forth in claim 1, wherein said benefit composition performs a benefit comprising one or more of softness enhancement, color protection, whiteness protection, stain repellency, scent enhancement, static reduction, bacterial reduction and wrinkle reduction.

5. A process as set forth in claim 1, wherein said dosage amount varies with the benefit level selected.

6. A process as set forth in claim 1, wherein said step of selecting at least one dosage amount for said benefit composition based on said selected benefit level comprises the step of selecting a total time amount for dispensing said benefit composition during said fabric enhancement operation based on said selected benefit level.

7. A process for applying a benefit composition to at least one fabric article during a fabric enhancement operation comprising the steps of:
selecting via an input device a desired one of two or more levels of a benefit to be provided by said benefit composition to said at least one fabric article; and
selecting an optimum time for applying said benefit composition to said at least one fabric article during said fabric enhancement operation based on said selected benefit level.

8. A process as set forth in claim 7, wherein said fabric enhancement operation comprises a fabric drying operation.

9. A process as set forth in claim 7, wherein said fabric enhancement operation comprises a fabric tumbling operation.

10. A process as set forth in claim 7, wherein said benefit composition provides a benefit comprising one or more of softness enhancement, color protection, whiteness protection, stain repellency, scent enhancement, static reduction, bacterial reduction and wrinkle reduction.

11. A process as set forth in claim 10, wherein said step of selecting a desired one of two or more levels of a benefit comprises the step of selecting a desired one of a first light benefit level and a second strong benefit level.

12. A process as set forth in claim 11, wherein said step of selecting an optimum time for applying said benefit composition comprises the steps of:
applying said benefit composition during an initial portion of said fabric enhancement operation when said first light benefit level is selected and said benefit composition provides a benefit comprising one or more of scent enhancement, static reduction, bacterial reduction and wrinkle reduction;
applying said benefit composition during a final portion of said fabric enhancement operation when said first light benefit level is selected and said benefit composition provides a benefit comprising one or more of softness enhancement, color protection, whiteness protection, and stain repellency;
applying said benefit composition during an initial portion of said fabric enhancement operation when said second strong benefit level is selected and said benefit composition provides a benefit comprising one or more of softness enhancement, color protection, whiteness protection, and stain repellency; and
applying said benefit composition during an final portion of said fabric enhancement operation when said second strong benefit level is selected and said benefit composition provides a benefit comprising one or more of scent enhancement, static reduction, bacterial reduction and wrinkle reduction.

13. A process for applying a benefit composition to at least one fabric article during a fabric enhancement operation comprising the steps of:
selecting a desired one of two or more levels of a first benefit to be provided by said benefit composition to said at least one fabric article;
selecting a desired one of two or more levels of a second benefit to be provided by said benefit composition to said at least one fabric article; and
selecting at least one dosage amount for applying said benefit composition to said fabric article during said fabric enhancement operation based on said selected first and second benefit levels.

14. A process as set forth in claim 13, wherein said fabric enhancement operation comprises a fabric tumbling operation.

15. A process as set forth in claim 13, wherein said fabric enhancement operation comprises a fabric drying operation.

16. A process as set forth in claim 13, wherein said step of selecting at least one dosage amount for applying said benefit composition comprises the steps of:
selecting a total amount of said benefit composition to be dispensed during said fabric enhancement operation based on said first selected benefit level; and
selecting a ratio of an amount of said benefit composition to be dosed beginning at a first juncture during said fabric enhancement operation to an amount of said benefit composition to be dosed beginning at a second juncture during said fabric enhancement operation, said ratio being selected based on said selected second benefit level.

17. A process as set forth in claim 16, wherein said step of selecting a total amount of said benefit composition to be dispensed comprises the step of selecting a total time amount for dispensing said benefit composition during said fabric enhancement operation and said step of selecting a ratio comprises the step of selecting a ratio of a first time period starting at said first juncture during which said benefit composition is dispensed to a second time period starting at said second juncture during which said benefit composition is dispensed.

18. A process as set forth in claim 17, wherein said step of selecting at least one dosage amount for applying said benefit composition further comprises the steps of:
determining said first time period starting at said first juncture during which said benefit composition is dispensed by multiplying said total time amount for dispensing said benefit composition during said operation by said ratio; and
determining said second time period starting at said second juncture during which said benefit composition is dispensed by multiplying said total time amount for dispensing said benefit composition during said operation by (1 minus said ratio).

19. A process as set forth in claim 13, wherein said first benefit comprises one or more of softness enhancement, color protection, whiteness protection and stain repellency, and said second benefit comprises one or more of scent enhancement, static reduction, bacterial reduction and wrinkle reduction.

20. A process as set forth in claim 13, wherein said step of selecting at least one dosage amount for applying said benefit composition to said fabric article comprises the steps of:
selecting one of two or more load sizes of said at least one fabric article to receive said benefit composition;
selecting a nominal dispense time for dispensing said benefit composition based on said selected load size;
selecting a dose increment based on said first selected benefit level;
determining a total time amount for dispensing said benefit composition during said fabric enhancement operation by multiplying said dose increment by said nominal dispense time; and
selecting a ratio of a first time period beginning at a first juncture during which said benefit composition is dispensed during said fabric enhancement operation to a second time period beginning at a second juncture during which said benefit composition is dispensed during said during said fabric enhancement operation, said ratio being selected based on said selected second benefit level.

21. A process for applying a benefit composition to at least one fabric article during a fabric enhancement operation comprising the steps of:
selecting via an input device a desired one of two or more levels of a benefit to be provided by said benefit composition to said at least one fabric article; and
selecting at least one dosage amount for applying said benefit composition to said fabric article during said fabric enhancement operation based on said selected benefit level.

22. A process as set forth in claim 21, wherein said fabric enhancement operation comprises a fabric tumbling operation.

23. A process as set forth in claim 21, wherein said fabric enhancement operation comprises a fabric drying operation.

24. A process as set forth in claim 21, wherein said step of selecting at least one dosage amount for applying said benefit composition comprises the steps of:
selecting one of two or more load sizes of said at least one fabric article to receive said benefit composition;
selecting a total amount of said benefit composition to be dispensed during said fabric enhancement operation based on said selected load size; and
selecting a ratio of an amount of said benefit composition to be dosed beginning at a first juncture during said fabric enhancement operation to an amount of said benefit composition to be dosed beginning at a second juncture during said fabric enhancement operation, said ratio being selected based on said selected benefit level.

25. A process as set forth in claim 24, wherein said step of selecting a total amount of said benefit composition to be dispensed comprises the step of selecting a total time amount for dispensing said benefit composition during said fabric enhancement operation and said step of selecting a ratio comprises the step of selecting a ratio of a first time period starting at said first juncture during which said fabric treatment is dispensed to a second time period starting at said second juncture during which said fabric treatment is dispensed.

26. A process as set forth in claim 24, wherein said benefit to be provided by said benefit composition to said at least one fabric article comprises one or more of scent enhancement, static reduction, bacterial reduction and wrinkle reduction.

27. A process for applying first and second benefit compositions to at least one fabric article during a fabric enhancement operation comprising the steps of:
selecting a desired one of two or more levels of a first benefit to be provided by said first benefit composition to said at least one fabric article;
selecting a desired one of two or more levels of a second benefit to be provided by said second benefit composition to said at least one fabric article;
selecting at least one dosage amount and a corresponding optimum time for applying said first benefit composition to said fabric article during said fabric enhancement operation based on said selected first benefit level; and
selecting at least one dosage amount and a corresponding optimum time for applying said second benefit composition to said fabric article during said fabric enhancement operation based on said selected second benefit level.

28. A process as set forth in claim 27, wherein said fabric enhancement operation comprises a fabric tumbling operation.

29. A process as set forth in claim 27, wherein said fabric enhancement operation comprises a fabric drying operation.

30. An apparatus for dispensing a benefit composition to at least one fabric article being processed within a chamber of a fabric enhancement apparatus comprising:
structure for dispensing said benefit composition to said at least one fabric article during a fabric enhancement operation occurring within said fabric enhancement apparatus chamber;
an input device allowing a user to select a desired one of two or more levels of a benefit to be provided by said benefit composition to said at least one fabric article; and
a controller coupled to said input device and selecting at least one dosage amount for said benefit composition based on said selected benefit level, said controller causing said dispensing structure to dispense said benefit composition onto said at least one fabric article in accordance with said selected dosage amount.

31. An apparatus as set forth in claim 30, wherein said fabric enhancement apparatus comprises a dryer.

32. An apparatus as set forth in claim 30, wherein said structure, input device and controller comprise a stand-alone unit separate from said fabric enhancement apparatus.

33. An apparatus as set forth in claim 30, wherein said structure, input device and controller comprise integral parts of said fabric enhancement apparatus.

34. An apparatus as set forth in claim 30, wherein said benefit composition performs a benefit comprising one or more of softness enhancement, color protection, whiteness protection, stain repellency, scent enhancement, static reduction, bacterial reduction and wrinkle reduction.

35. An apparatus as set forth in claim 30, wherein said controller causes said dosage amount to vary with the benefit level selected.

36. An apparatus as set forth in claim 30, wherein said controller selects said at least one dosage amount for said benefit composition by selecting a total time amount for dispensing said benefit composition during said fabric enhancement operation based on said selected benefit level.

37. An apparatus for dispensing a benefit composition to at least one fabric article being processed within a chamber of a fabric enhancement apparatus comprising:
structure for dispensing said benefit composition to said at least one fabric article during a fabric enhancement operation occurring within said fabric enhancement apparatus chamber;
an input device for selecting a desired one of two or more levels of a benefit to be provided by said benefit composition to said at least one fabric article; and
a controller for selecting an optimum time for applying said fabric treatment to said at least one fabric article during said fabric enhancement operation based on said selected benefit level, said controller causing said dispensing structure to dispense said benefit composition onto said at least one fabric article at said selected optimum time.

38. An apparatus as set forth in claim 37, wherein said fabric enhancement apparatus comprises a dryer.

39. An apparatus as set forth in claim 37, wherein said structure, input device and controller comprise a stand-alone unit separate from said fabric enhancement apparatus.

40. An apparatus as set forth in claim 37, wherein said structure, input device and controller comprise integral parts of said fabric enhancement apparatus.

41. An apparatus as set forth in claim 37, wherein said benefit composition performs a benefit comprising one or more of softness enhancement, color protection, whiteness protection, stain repellency, scent enhancement, static reduction, bacterial reduction and wrinkle reduction.

42. An apparatus as set forth in claim 37, wherein said input device allows a user to select a desired one of a first low benefit level and a second high benefit level.

43. An apparatus as set forth in claim 42, wherein said controller selects an optimum time for applying said benefit composition such that:
said benefit composition is applied by said structure during an initial portion of said fabric enhancement operation when said first low benefit level is selected and said benefit composition provides a benefit comprising one or more of scent enhancement, static reduction, bacterial reduction and wrinkle reduction;
said benefit composition is applied by said structure during an final portion of said fabric enhancement operation when said first low benefit level is selected and said benefit composition provides a benefit comprising one or more of softness enhancement, color protection, whiteness protection, and stain repellency;
said benefit composition is applied by said structure during an initial portion of said fabric enhancement operation when said second high benefit level is selected and said benefit composition provides a benefit comprising one or more of softness enhancement, color protection, whiteness protection, and stain repellency; and
said benefit composition is applied by said structure during an final portion of said fabric enhancement operation when said second high benefit level is selected and said benefit composition provides a benefit comprising one or more of scent enhancement, static reduction, bacterial reduction and wrinkle reduction.

44. A process for applying a benefit composition to at least one fabric article during a fabric enhancement operation comprising the steps of:
selecting at least one of first and second benefits capable of being provided by said benefit composition to said at least one fabric article; and
selecting one or more optimum times for applying said benefit composition to said at least one fabric article during said fabric enhancement operation based on said selected one or more benefits.

45. A process as set forth in claim 44, wherein said fabric enhancement operation comprises a fabric drying operation.

46. A process as set forth in claim 44, wherein said fabric enhancement operation comprises a fabric tumbling operation.

47. A process as set forth in claim 44, wherein said benefit composition is capable of providing a first benefit comprising one or more of softness enhancement, color protection, whiteness protection, and stain repellency, and a second benefit comprising one or more of scent enhancement, static reduction, bacterial reduction and wrinkle reduction.

48. A process as set forth in claim 47, wherein said step of selecting an optimum time for applying said benefit composition comprises the steps of:
applying at least a substantial portion of said benefit composition during an initial portion of said fabric enhancement operation when said first benefit is selected;
applying at least a substantial portion of said benefit composition during a final portion of said fabric enhancement operation when said second benefit is selected;
applying a significant portion of said benefit composition during each of initial and final portions of said fabric enhancement operation when said first and second benefits are selected.
